(19) United States
(12) Patent Application Publication
(10) Pub. No.: US 2026/0004271 A1
(43) Pub. Date: Jan. 1, 2026

(54) Method to Recognize Items During Self-Checkout

(71) Applicant: Zebra Technologies Corporation, Lincolnshire, IL (US)

(72) Inventor: Duanfeng He, South Setauket, NY (US)

(21) Appl. No.: 18/759,796

(22) Filed: Jun. 28, 2024

(51) Int. Cl. G06Q 20/20; G06T 7/246; G06V 10/14; G06V 10/26; G06V 10/82; G06V 20/50

(52) U.S. Cl. CPC G06Q 20/208; G06T 7/248; G06V 10/14; G06V 10/26; G06V 10/82; G06V 20/50; G06T 2207/20084

(57) ABSTRACT

Systems and methods to recognize items during self-checkout are disclosed herein. An example system includes: one or more processors; one or more sensors; one or more image acquisition assemblies; and one or more memories including computer-executable instructions stored thereon that cause the system to: detect, via the one or more sensors, a motion within an area of interest of one or more areas of interest; obtain, from the one or more image acquisition assemblies, a first image dataset of the area of interest captured prior to the detected motion; obtain, from the one or more image acquisition assemblies, a second image dataset of the area of interest captured after the detected motion; compare the first image dataset and the second image dataset to identify a group of pixels associated with the detected motion; and perform, based on the group of pixels identified, one or more actions.

### BACKGROUND

Checkout systems may be tasked with identifying a variety of different items. However, when many different items are present in one area of interest (such as a bagging area, a cart, etc.), checkout systems may misidentify an item or even fail to recognize the presence of the item among the many different items. Moreover, identifying multiple different items in the same area of interest may be computationally intensive and may require lengthy processing times.

### SUMMARY

In an embodiment, the present invention is an imaging system for recognizing items during self-checkout comprising: one or more processors; one or more sensors; one or more image acquisition assemblies configured to capture image datasets associated with one or more areas of interest; and one or more memories including computer-executable instructions stored thereon that, when executed by the one or more processors, cause the imaging system to: (i) detect, via the one or more sensors, a motion within an area of interest of the one or more areas of interest; (ii) obtain, from the one or more image acquisition assemblies, a first image dataset of the area of interest captured prior to the detected motion; (iii) obtain, from the one or more image acquisition assemblies, a second image dataset of the area of interest captured after the detected motion; (iv) compare the first image dataset and the second image dataset to identify a group of pixels associated with the detected motion; and (v) perform, based on the group of pixels identified, one or more actions.

In a variation of this embodiment, the imaging system comprises a barcode reader and the one or more memories include computer-executable instructions stored thereon that, when executed by the one or more processors, cause the imaging system to: (i) identify, via the barcode reader, an object associated with a symbology decoded by the barcode reader within a threshold period of time corresponding to the detected motion; and (ii) verify the object associated with the symbology may be represented by the group of pixels.

In another variation of this embodiment, the object is verified based on comparing characteristics of the object associated with the symbology with one or more of: (i) a size of the group of pixels, (ii) a color of the group of pixels, or (iii) a shape of the group of pixels.

In another variation of this embodiment, the one or more actions include one or more of: (i) attempting to verify that the group of pixels associated with detected motion corresponds to the object associated with the symbology decoded by the barcode reader; (ii) attempting to identify, based on the group of pixels associated with the detected motion, a detected object, and comparing the detected object with the object associated with a symbology decoded by the barcode reader; and (iii) in response to failing to verify the group of pixels or failing to identify the detected object, generate an alert indicating the symbology decoded by the barcode reader needs to be checked for accuracy.

In another variation of this embodiment, an artificial neural network is used to (i) verify that the group of pixels corresponds to the object associated with the symbology decoded by the barcode reader and (ii) identify the detected object.

In another variation of this embodiment, comparing the first image dataset and second image dataset further comprises: (i) identifying the group of pixels based on the group of pixels having different corresponding pixel values in the first image dataset and the second image dataset; (ii) segmenting the group of pixels from the first image dataset or the second image dataset to generate a segmented image dataset; and (iii) analyzing the segmented image dataset to identify an object.

In another variation of this embodiment, segmenting the group of pixels from the first image dataset or the second image dataset further comprises: (i) identifying one or more subgroups of contiguous pixels in the group of pixels; and (ii) segmenting the one or more subgroups of contiguous pixels from the first image dataset or the second image dataset, thereby generating the segmented image dataset.

In another variation of this embodiment, identifying the group of pixels is based on the one or more subgroups of contiguous pixels identified exceeding threshold number of pixels.

In another variation of this embodiment, the one or more memories include computer-executable instructions stored thereon that, when executed by the one or more processors, cause the imaging system to: determine, based on the differences in pixel value between corresponding pixels in the first image dataset and the second image dataset, a pixel change average of the differences in pixel value for each respective subgroup of contiguous pixels.

In another variation of this embodiment, identifying the group of pixels is based on the one or more subgroups of contiguous pixels exceeding a threshold pixel change average.

In another variation of this embodiment, the one or more image acquisition assemblies are positioned proximate to a self-checkout station and the one or more areas of interest are proximate to the self-checkout station.

In another variation of this embodiment, each image acquisition assembly includes a respective imaging assembly that has a field of view (FOV) directed towards a respective area of interest of the one or more areas of interest proximate to the self-checkout station.

In another embodiment, the present invention is a computer-implemented method for recognizing items during self-checkout including: (i) detecting, via the one or more sensors, a motion within an area of interest of one or more areas of interest; (ii) obtaining, from one or more image acquisition assemblies, a first image dataset of the area of interest captured prior the detected motion; (iii) obtaining, from the one or more image acquisition assemblies, a second image dataset of the area of interest captured after the detected motion; (iv) comparing the first image dataset and the second image dataset to identify a group of pixels associated with the detected motion; and (v) performing, based on the group of pixels identified, one or more actions.

In a variation of this embodiment, the computer implemented method further comprises: (i) identifying, via a barcode reader, an object associated with a symbology decoded by the barcode reader within a threshold period of time corresponding to the detected motion; and (ii) verifying the object associated with the symbology may be represented by the group of pixels.

In another variation of this embodiment, the object is verified based on comparing characteristics of the object associated with the symbology with one or more of: (i) a size of the group of pixels, (ii) a color of the group of pixels, or (iii) a shape of the group of pixels.

In another variation of this embodiment, the one or more actions include one or more of: (i) attempting to verify that the group of pixels associated with detected motion corresponds to the object associated with the symbology decoded by the barcode reader; (ii) attempting to identify, based on the group of pixels associated with the detected motion, a detected object, and comparing the detected object with the object associated with a symbology decoded by the barcode reader; and (iii) in response to failing to verify the group of pixels or failing to identify the detected object, generate an alert indicating the symbology decoded by the barcode reader needs to be checked for accuracy.

In another variation of this embodiment, an artificial neural network is used to (i) verify that the group of pixels corresponds to the object associated with the symbology decoded by the barcode reader and (ii) identify the detected object.

In another variation of this embodiment, comparing the first image dataset and second image dataset further comprises: (i) identifying the group of pixels based on the group of pixels having different corresponding pixel values in the first image dataset and the second image dataset; (ii) segmenting the group of pixels from the first image dataset or the second image dataset to generate a segmented image dataset; and (iii) analyzing the segmented image dataset to identify an object.

In another variation of this embodiment, segmenting the group of pixels from the first image dataset or the second image dataset further comprises: (i) identifying one or more subgroups of contiguous pixels in the group of pixels; and (ii) segmenting the one or more subgroups of contiguous pixels from the first image dataset or the second image dataset, thereby generating the segmented image dataset.

In another variation of this embodiment, identifying the group of pixels is based on the one or more subgroups of contiguous pixels identified exceeding threshold number of pixels.

In another variation of this embodiment, the computer implemented method further comprises: determining, based on the differences in pixel value between corresponding pixels in the first image dataset and the second image dataset, a pixel change average of the differences in pixel value for each respective subgroup of contiguous pixels.

In another variation of this embodiment, identifying the group of pixels is based on the one or more subgroups of contiguous pixels exceeding a threshold pixel change average.

In another variation of this embodiment, the one or more image acquisition assemblies are positioned proximate to a self-checkout station and wherein the one or more areas of interest are proximate to the self-checkout station.

In another variation of this embodiment, each image acquisition assembly includes a respective imaging assembly that has a field of view (FOV) directed towards a respective area of interest of the one or more areas of interest proximate to the self-checkout station.

In yet another embodiment, the present invention is a non-transitory computer readable medium including program instructions that when executed by one or more processors, cause a computer to: (i) detect, via the one or more sensors, a motion within an area of interest of the one or more areas of interest; (ii) obtain, from the one or more image acquisition assemblies, a first image dataset of the area of interest captured prior to the detected motion; (iii) obtain, from the one or more image acquisition assemblies, a second image dataset of the area of interest captured after the detected motion; (iv) compare the first image dataset and the second image dataset to identify a group of pixels associated with the detected motion; and (v) perform, based on the group of pixels identified, one or more actions.

In a variation of this embodiment, the program instructions, when executed by the one or more processors, further cause the computer to: identify, via the barcode reader, an object associated with a symbology decoded by the barcode reader within a threshold period of time corresponding to the detected motion; and verify the object associated with the symbology may be represented by the group of pixels.

In another variation of this embodiment, the object is verified based on comparing characteristics of the object associated with the symbology with one or more of: (i) a size of the group of pixels, (ii) a color of the group of pixels, or (iii) a shape of the group of pixels.

In another variation of this embodiment, the one or more actions include one or more of: (i) attempting to verify that the group of pixels associated with detected motion corresponds to the object associated with the symbology decoded by the barcode reader; (ii) attempting to identify, based on the group of pixels associated with the detected motion, a detected object, and comparing the detected object with the object associated with a symbology decoded by the barcode reader; and (iii) in response to failing to verify the group of pixels or failing to identify the detected object, generate an alert indicating the symbology decoded by the barcode reader needs to be checked for accuracy.

In another variation of this embodiment, an artificial neural network is used to (i) verify that the group of pixels corresponds to the object associated with the symbology decoded by the barcode reader and (ii) identify the detected object.

In another variation of this embodiment, comparing the first image dataset and second image dataset further comprises: identifying the group of pixels based on the group of pixels having different corresponding pixel values in the first image dataset and the second image dataset; segmenting the group of pixels from the first image dataset or the second image dataset to generate a segmented image dataset; and analyzing the segmented image dataset to identify an object.

In another variation of this embodiment, segmenting the group of pixels from the first image dataset or the second image dataset further comprises: identifying one or more subgroups of contiguous pixels in the group of pixels; and segmenting the one or more subgroups of contiguous pixels from the first image dataset or the second image dataset, thereby generating the segmented image dataset.

In another variation of this embodiment, identifying the group of pixels is based on the one or more subgroups of contiguous pixels identified exceeding threshold number of pixels.

In another variation of this embodiment, the program instructions, when executed by the one or more processors, further cause the computer to: determine, based on the differences in pixel value between corresponding pixels in the first image dataset and the second image dataset, a pixel change average of the differences in pixel value for each respective subgroup of contiguous pixels.

In another variation of this embodiment, identifying the group of pixels is based on the one or more subgroups of contiguous pixels exceeding a threshold pixel change average.

In another variation of this embodiment, the one or more image acquisition assemblies are positioned proximate to a self-checkout station and wherein the one or more areas of interest are proximate to the self-checkout station.

In another variation of this embodiment, each image acquisition assembly includes a respective imaging assembly that has a field of view (FOV) directed towards a respective area of interest of the one or more areas of interest proximate to the self-checkout station.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B illustrate perspective views of a gateway scanner with two branching arms.

FIG. 2 illustrates a perspective view of the gateway scanner of FIGS. 1A and 1B in self-checkout location of a retail environment.

FIGS. 3A, 3B, 3C, and 3D are different perspective views of the gateway scanner of FIGS. 1A and 1B illustrating different imager fields of view.

FIGS. 4A, 4B, and 4C are different plan views of the gateway scanner of FIGS. 1A and 1B illustrating a 360° nature of the resulting scan volume.

FIG. 5 illustrates a perspective view of the gateway scanner of FIGS. 1A and 1B in another retail environment.

FIG. 6 illustrates a perspective view of the gateway scanner of FIGS. 1A and 1B in self-checkout location of a retail environment having a conveyor system.

FIG. 7 illustrates a perspective view of an alternative gateway scanner having wide-angle field of view imagers and in self-checkout location of a retail environment.

FIG. 8 illustrates a side view of another gateway scanner having a hinge for placing the scanner in a fully-folded position.

FIGS. 9A, 9B, and 9C are perspective views of another gateway scanner integrated with components forming a scanning station.

FIGS. 10A and 10B illustrate perspective views of a gateway scanner having a single extension arm.

FIGS. 11A and 11B are perspective views of the gateway scanner of FIGS. 10A and 10B illustrating different imager fields of view.

FIG. 12 illustrates a perspective view of the gateway scanner of FIGS. 10A and 10B in a retail environment.

FIG. 13 illustrates a perspective view of an alternative gateway scanner having a single extension arm and having wide-angle field of view imagers and in self-checkout location of a retail environment.

FIG. 14 illustrates a perspective view of another gateway scanner with two branching arms.

FIG. 15 is a block diagram of an example computing environment for implementing example methods and/or operations described herein.

FIG. 16A depicts an exemplary image of a checkout area before a motion is detected, FIG. 16B depicts an exemplary image of checkout area after a motion is detected, FIG. 16C depicts an exemplary image of an identified object in a self-checkout area.

FIG. 17 depicts an exemplary computer-implemented method for recognizing items during self-checkout, in accordance with the techniques disclosed herein, according to an aspect.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present aspects may relate to, inter alia, an imaging system for recognizing items during self-checkout as the items are moved from one area to another. An example imaging system may detect a motion within an area of interest of a self-checkout station (e.g., a scanning area, a bagging area, etc.), and obtain image data corresponding to the area of interest from both before and after the motion. For instance, the motion may be the motion of an item being added to or removed from the area of interest. The imaging system may compare the image data captured before the detected motion to the image data captured after the detected motion to identify a change in the image data associated with the detected motion. Accordingly, an item that is added to or removed from the area of interest may be identified in the image data based on a comparison of the image data captured before and after the detected motion (e.g., as the moved item either appears or disappears from the image data). More specifically, the imaging system may identify a group of pixels in the example image data that has changed (e.g., based on corresponding pixel values in image data captured before and after the motion) and segment that group of pixels from the image data to generate segmented image data that includes the identified group of pixels. The segmented image data may then be analyzed to identify the object that was added to or removed from the area of interest, or to confirm the identity of the object that was added to or removed from the area of interest (i.e., by comparing visual characteristics of an object identified based on reading a barcode or other indicia or symbology to characteristics of the segmented image data).

Advantageously, identifying pixels associated with the detected motion avoids the need to expend computational resources and/or processing time searching the entire image dataset to locate a particular item (i.e., searching the image dataset for an item associated with a barcode or other indicia recently decoded by a barcode reader), and reduces the possibility of confusing an item of interest with another item in the area of interest. Moreover, analyzing only the segmented image data associated with the detected motion in order to identify or confirm the identity of the item may be less computationally intensive than analyzing the entire image dataset to identify the item and may prevent other items in the area of interest from influencing the identification of the item of interest.

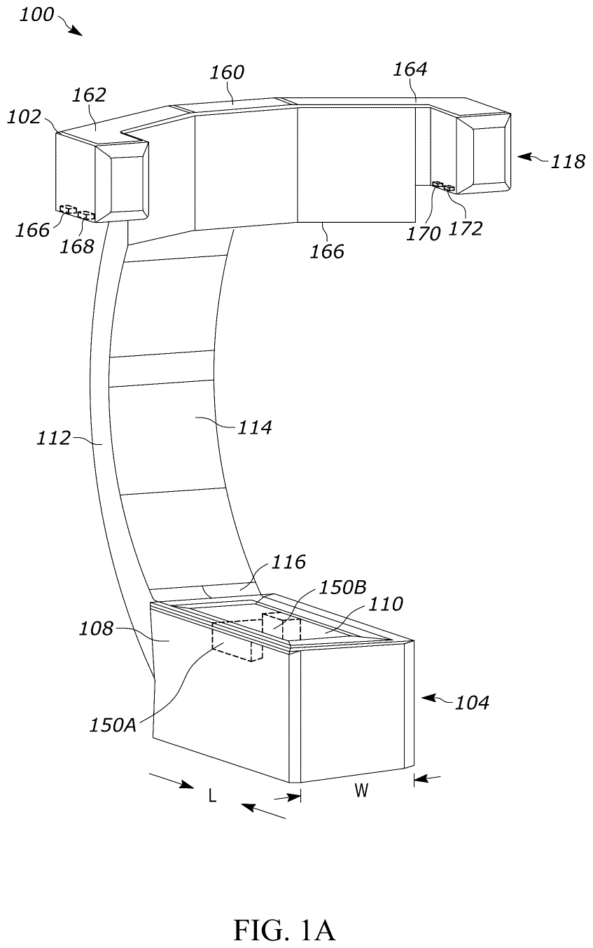

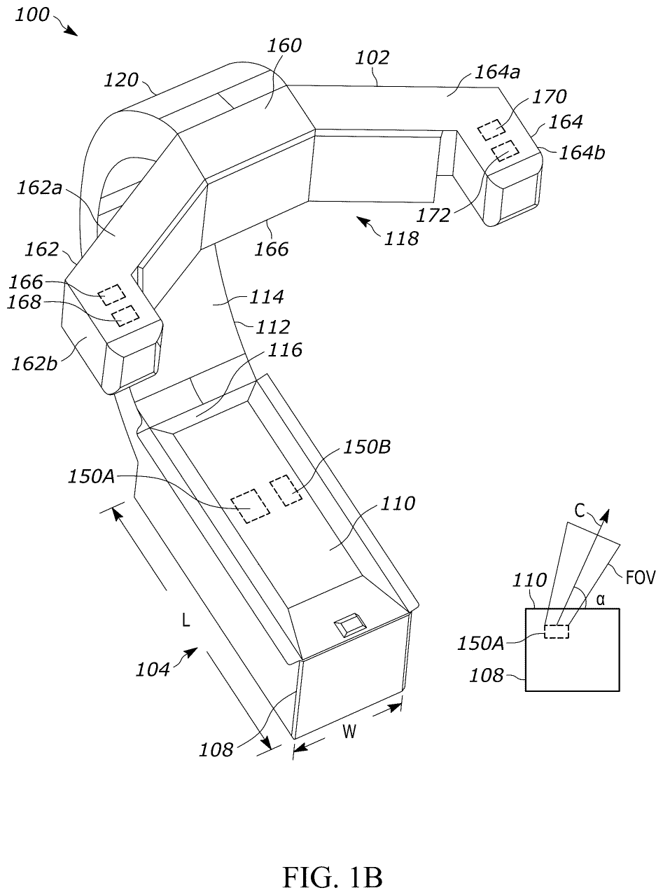

As shown in FIGS. 1A and 1B, a scanner 100 with a narrow-profile integrated design is shown. The scanner 100 includes a housing 102 having a lower portion 104 that defines a bottom extent of a scan region 106. The lower portion 104, in the illustrated example, has bottom frame 108 in which an opening is formed for placement of a transparent exit window 110, formed of a scratch resistance glass, for example. An upper surface of that exit window 110 provides a scan surface. A user scans an object by moving it from one side of the scan region 106 above the window to the other side of the scan region 106. In the illustrated example, the scan region 106 may be a narrow scan region. For example, the scan region 106 may be limited in width to the width, W, of the bottom frame 108. In some examples, the scan region 106 may be larger than this width, W, or smaller than this width, W. This lateral width, W, may be between 7 inches and 12 inches in some examples, and preferably no more than 10 inches. To maintain the narrow-profile, in some examples, a ratio of a vertical height, H, of the scanner to a lateral width of the scanner is at least 2:1. In some examples, the vertical height, H, is between 15 inches and 30 inches, for example.

The exit window 110 can further provide a placement surface upon which objects to be scanned may be placed, for example, when the bottom frame 108 includes an integrated weigh platter, as discussed in various examples herein.

As shown in FIGS. 1A and 1B, an extension arm 112 extends upward from the bottom frame 108 and is characterized, at least in the illustrated example, by having an arcuate side profile that can be sized to allow the scan region 106 to extend the full length of the exit window 110, the full length, L, of the bottom frame 108, or to extend a greater length than the full length, L. For example, the extension arm 112 may have an arcuate inner wall surface 114 that extends from a distal end 116 of the bottom frame 108 at the lower portion 104 of scanner 100 to an upper portion 118 of the scanner 100 where a mounting structure is provided for downwardly directing one or more imagers. The arcuate wall surface 114 may have a radius selected based on the size of the scan region desired, the amount of clearance desired for moving an object across a scan region (for example, for scanning objects that are larger than a scan region), or a radius determined from other factors, such as the desired height of the upper portion 118. In some examples, the extension arm 112 has as arcuate outer wall surface 120 in addition to the arcuate inner wall surface 114. However, in other examples, the outer wall surface 120 may have a flat or other profile. Similarly, the inner wall surface 114 may have a flat or other profile in other examples.

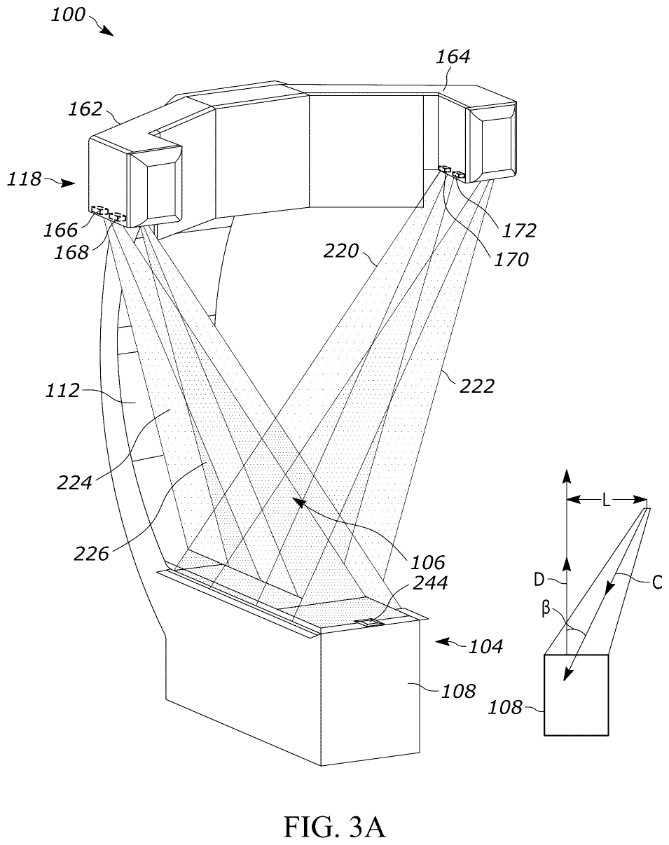

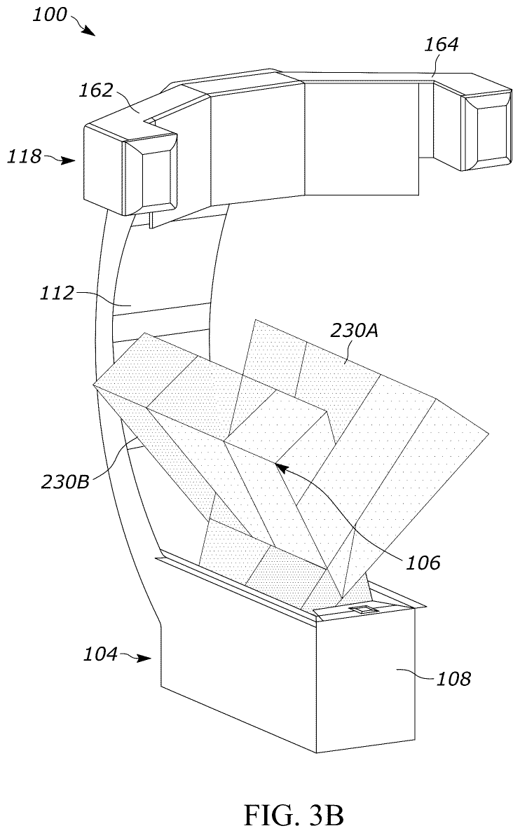

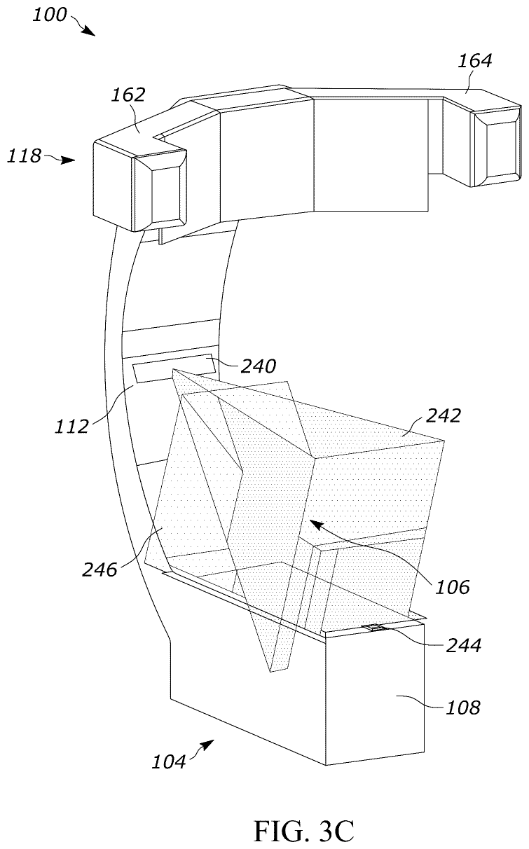

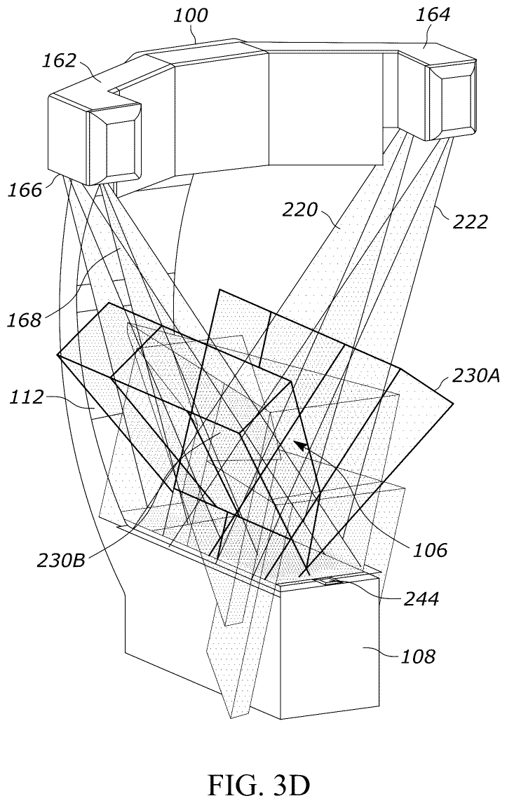

In the illustrated example, the bottom frame 108 houses one or more upwardly directed imagers 150A and 150B (where two are shown) that each have a field of view extending upwardly through the exit window 110. For example, the one or more imagers 150A/150B may have fields of view that extend vertically or substantially vertically through the exit window to coincide with the scan region 106. As used herein substantially vertically includes any field of view having a central axis, C, that forms an angle, a, with the horizontal plane of the exit window 110 that is at least 10°, from a side view, where 90° refers to absolute vertical. In other examples, the angle is from 10° up to but excluding 90°, or more preferably from 20° up to but excluding 90, or more preferably still from 30° up to but excluding 90°. Example resulting fields of view are shown in FIGS. 3A-3D, discussed further below.

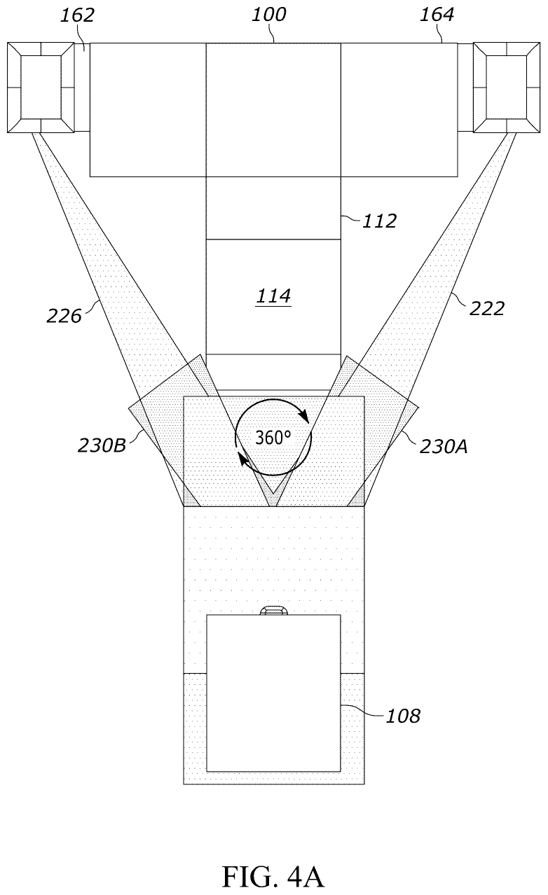

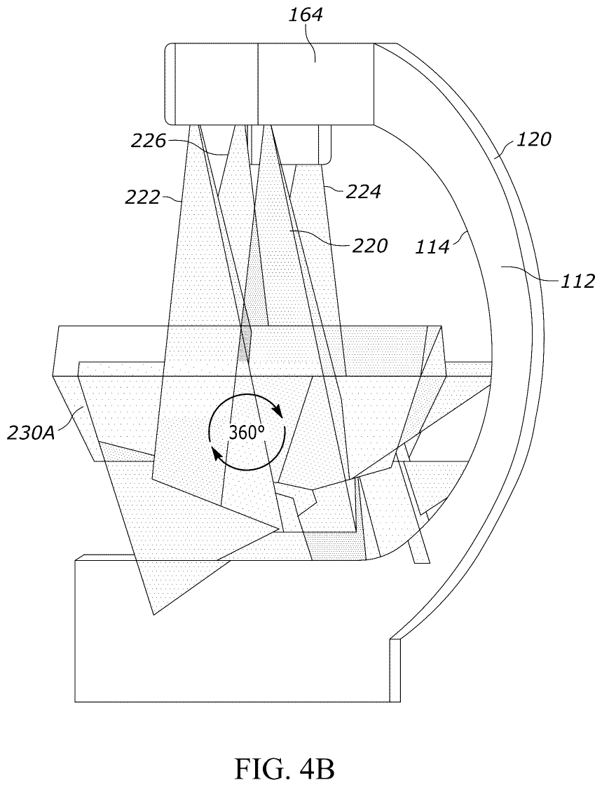

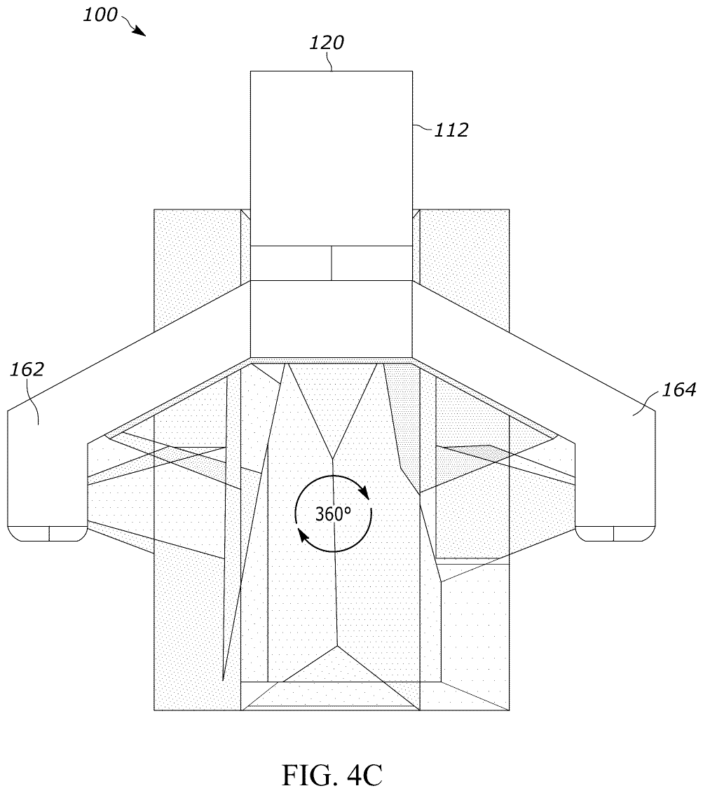

In the illustrated example, the scanner 100 includes at the upper portion 118, a branching mount 160 integrated with the extension arm 112 and having two branching arms 162 and 164, each extending in opposing lateral directions away from a center region where the upper portion 118 is supported by the extension arm 112. In the illustrated example, the mount 160 includes an upper support frame 160 that rigidly supports each of the branching arms 162, 164 to the extension arm 112. The branching arms 162, 164 are multi-segment arms in the illustrated example, although any suitable configuration may be achieved. The branching arm 162 includes a first segment 162A that is deflecting in a horizontal direction but with an inward pitch formed by a pitch angle, where that first segment 162A terminates at second segment 162B that provides a mount for one or more downwardly directed imagers. In this way, the branching arm 162 mounts its one or more downwardly directed imagers at a lead-out side of the scanner 100, for example, extending over a portion or a bagging area or at least over a lead-out region adjacent a bagging area. Similarly, the branching arm 164 includes segments 164A and 164B having the same orientation but where the one or more downwardly directed imagers are at a lead-in side of the scanner 100, for example, extending over a portion of shopping cart area or at least over a lead-in region adjacent that shopping cart area. That is, the examples show downwardly directed imagers are positioned outside (whether distally, proximally, or laterally) of outer edges of the exit window 110 when viewed in a plan view from above (see, e.g., FIG. 4C) or front view (see, e.g., FIG. 4A). In the illustrated example, these downwardly directed imagers are positioned outside of outer boundaries of the entire lower portion 104 of the housing 102 when viewed in a plan view from above.

In the illustrated example, each of the segments 162B and 164B mount one or more imagers. In the illustrated example, the imaging assembly of the scanner 100 includes two imagers 166/168 mounted in segment 162B and two imagers 170/172 are mounted in segment 124B. Alternatively, in other examples, the imaging assembly of the scanner 100 includes only one imager 166 mounted in the segment 162B and the other imager 170 mounted in the segment 162B. Furthermore, each of these imagers, i.e., imagers 166 and 170 in the single imager example or imagers 166/168 and 170/172 in the dual imager examples (as shown in FIGS. 3A-3D), are mounted in the upper portion such that their respective fields of view extend downwardly toward the lower portion 104 with each respective field of view having a central axis that is offset with respect to a center normal of the exit window 110 in the lower portion 104. In some examples, the upper portion 118 is configured such that the imagers 166/168 and 170/172 directedly downwardly and biased in the direction of a user positioned for scanning objects using the scanner 100. In some examples, the upper portion 118 is configured such that an upper imaging assembly has one or more imagers mounted in each branching arms 162/164 and such that their fields of view are offset from the center normal of the exit window by an equal and opposite offset distance. In some examples, that offset distance is greater than half a lateral width of the lower portion 104. In some examples, the upper portion 118 is configured such that the fields of view extend downwardly toward the lower portion 104, which each field of view central axis obliquely angled with respect to the center normal of the exit window, e.g., obliquely angled by equal and opposite angles.

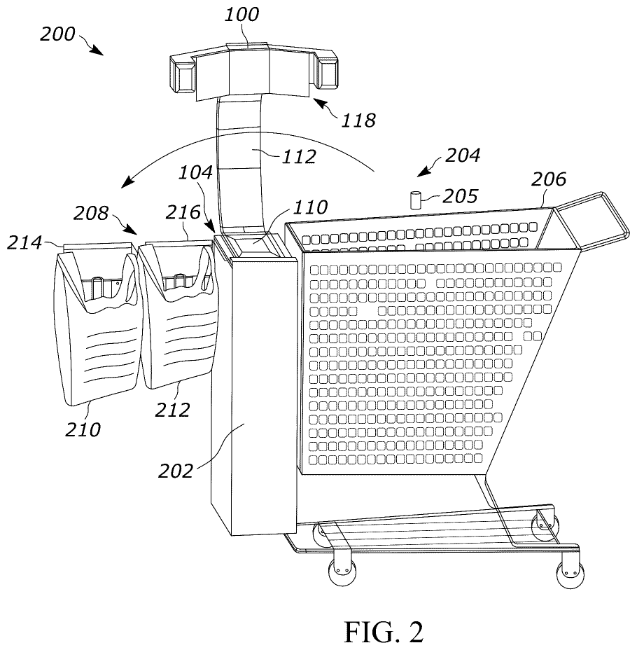

FIG. 2 illustrates the scanner 100 positioned in self-checkout location 200 of a retail environment. The bottom frame 108 of the scanner 100 is mounted in a support structure 202 that extends from a floor and that resulting positions the scanner 100 between (i) a lead-in region in the form of a shopping cart area 204 shown having a shopping cart 206 and (ii) lead-out region in the form of a bagging area 208 shown with bags 210/212 mounted to bagging frames 214/216, respectively. A general direction of movement of an object 205 from the area 204 to the area 208 is shown, although the scanner 100 may be agnostic to the direction of movement from one area to the other, allowing scanning of an object regardless of direction of movement across a scan region.

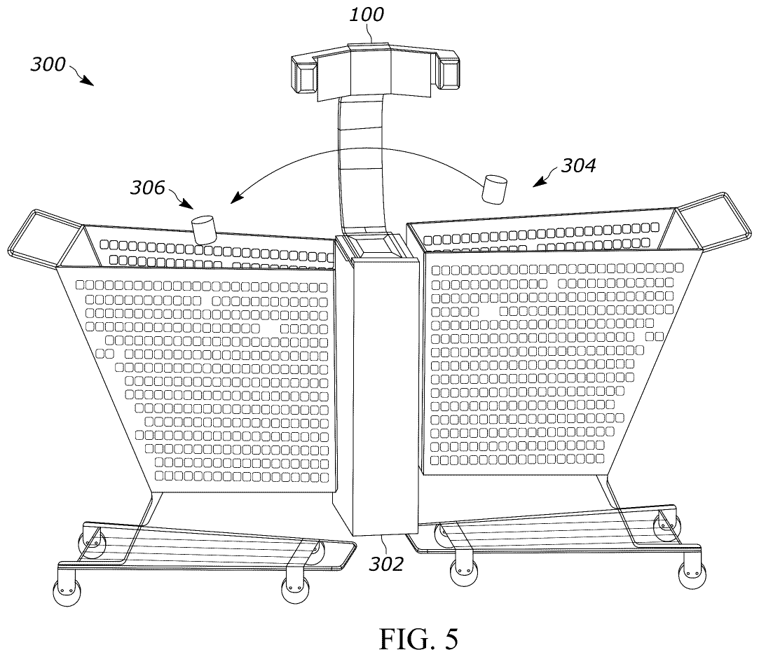

FIG. 2 (along with FIG. 5 and other figures) illustrates a feature of any of the various examples wherein, namely that the narrow width of a scanner combined with the positioning of the lead-in region and the lead-out region allows for the most natural movement and lowest effort between the two, thereby encouraging users to follow a natural path through the scan region. Also, a narrow scanner can be sized such that there is not any place to put items down on the scanner, which encourages users to pick up an item right out of the shopping cart and immediately scan it and place in a bag, without adding a step in the middle of scanning such as putting an item down. Removing that step can help avoid accidental scans of items left near a scanner and also can help ensure that those items are all in appropriate positions to be monitored by externa vision systems or personnel.

FIGS. 3A-3D illustrate example fields of a view of different imagers in the scanner 100. Imagers 170/172 have corresponding fields of view 220/222 that are downwardly directed. The FsOV 220/222 may have central axes, C, having a origin point that is laterally offset by a distance, λ, from a center normal axis, D, of the exit window 110. In some examples, the FsOV 220/222 are downwardly directed toward that center normal axis, D, at an oblique angle, β, with respect to that center normal axis to overlap with the scan region 106. Correspondingly, the imagers 166/168 have corresponding FsOV 224/226 that may have central axes that are laterally offset from the center normal axis, D, of the exit window 110. In some examples, the FsOV 224/226 are downwardly directed toward that center normal axis, D, at an oblique angle.

While illustrated in some examples, the downwardly directed FsOV of scanners in accordance with the present teachings may result from many different combinations of imagers and FsOV so long as adequate image resolution and coverage is provided to fully cover the lower portion of the housing and to decode indicia at any upward-facing orientation before that indicia is identified by any upward-looking FsOV emanating from the lower portion. Further, in various examples, any combination of different FsOV emanating from the scanner could be used to overlap to define scan region while providing angular coverage adequate to ensure that an indicia is identifiable and scannable on any of the 6 sides of a rectangular-shaped object oriented in any direction, thus the indication of 360° in the examples of FIGS. 4A-4C.

In the illustrated example, the imagers 170/172 define a first edge plane of the scan region, and the FsOV 224/226 may each define a second edge plane of the scan region. These first and second edge planes can define first and second outer extents of the scan region 106, for example. In the illustrated example, the branching arms 162, 164 position respective imagers to generate angled first and second edge planes, as measured against a vertical plane. Angled edge planes may be desired to provide a more confined scan region 106. The exact angle may be determined by the shape of the branching arms 162, 164, such as how far away they extend from the extension arm 112. Of course, in some examples, the orientation of the respective fields of view of the imagers in the branching arms 162, 164 may be determined from internal optics of the imagers, apertures of the imagers, or other confinement techniques. The fields of view 220/222/224/226 allow for scanning an object from the left side, the right side, and from the top.

FIG. 3B illustrates fields of view 230A and 230B corresponding to upwardly directed imagers 150A and 150B in the bottom frame 108. In the illustrated example, the imagers 150A/150B are mounted such that their corresponding fields of view 230A/230B are angled relative a vertical plane, that is, a center axis of the field of view forms an acute angle with the vertical plane. The fields of view 230A/230B allow for scanning an object from the left side, the right side, and from the bottom. As shown in FIG. 3D, the scan region 106 coincides with a scan volume defined by these fields of view 220/222/224/226/150A/150B.

FIG. 3C illustrates an example of the scanner 100, in which an additional (and optional) front directed imager 240 is positioned in the extension arm 112 and is characterized by a field of view 242 directed toward a user, where, as shown in FIG. 3D, that field of view 242 overlaps with the other fields of view 220/222/224/226/150A/150B to collectively define the scan region 106. The front directed imager 240 may be positioned at any suitable location on the extension arm 112. In some examples, a front directed imager is positioned at the distal end of the bottom frame 108. In some examples, the scanner 100 may further include a back directed imager 244, such as an imager at a proximal edge of the bottom frame 108 and having a field of view 246 directed toward the extension arm 112. In some examples, both FsOV 242 and 246 are narrow fields of view, such that both have a width generally confined to a scan region. In other examples, the back directed FOV 246 is narrow, and the front directed FOV 242 is a wide-angle field of view, for example, allowing for coverage that extends beyond the width of the bottom portion 104.

By having overlapping upwardly directed and downwardly directed fields of view and by having at least some of the downwardly directed fields of view angled downward and inward, the scanner 100 is able to achieve orientation independent scanning of indicia of an object, because of the scan volume defined by the overlapping fields of view. FIG. 4A shows an end on view of the scanner 100 indicating full 360° rotational freedom of object scanning in a first vertical plane; FIG. 4B shows a side view indicating full 360° rotational freedom in a second vertical plane; and FIG. 4C shows a top view indicating full 360° rotational freedom in a horizontal plane. FIG. 4A also shows how the FsOV collectively can be kept to a confined region over the lower portion 108, in order to not accidentally read indicia close to but beyond either side of the lower portion 108 before the indicia are passed through a scan region of the scanner 100.

As exemplified in FIGS. 4A-4C, and in other figures, in various examples here, scanner are provided in which a housing (lower portion, upper portion, and extension arm) are configured such that a single scan region has at least one side of free access to a user scanning an object from a lead-in region into a lead-out region. That free access is established by the absence of any physical structure in a natural scanning path of a user.

As further exemplified in FIGS. 4A-4C, and in other figures, scanners are described that may include a plurality of imaging assemblies, each having a field of view, and a housing mounting the plurality of imaging assemblies so that each field of view overlaps with at least one other of the fields of view such that all fields of view collectively form a scan volume. For example, the overlap may be such that the scan volume is able to scan an object over approximately 360 of rotational freedom® about all three orthogonal axes (e.g., cartesian coordinate system). Further, as exemplified the housing may have a lower portion, an upper portion, and an extension arm extending upward from the lower portion to the upper portion, and wherein at least one of the plurality of imaging assemblies is mounted in the upper portion and at least one other of the plurality of imaging assemblies is mounted in the lower portion. Further, as shown that housing may be shaped to form an arc of approximately 180° about the scan volume to provide a user free access to scan objects by passing the objects through the scan volume. To effect this, in some examples, the extension arm has arcuate shape extending from between the upper portion and the lower portion, and wherein an upper edge of the extension arm engaging the upper portion and a lower edge of the extension arm engaging the lower portion lie within a vertical plane.

An advantage of gateway scanner configurations such as those of scanner 100 is that they may be adapted into various different self-checkout environments. FIG. 5 illustrates an example of an environment 300 in which the scanner 100 is mounted in an opening of a support structure 302 positioned between two different shopping cart areas 304 and 306, either of which could be a lead-in region or a lead-out region depending which direction a user intends to scan items.

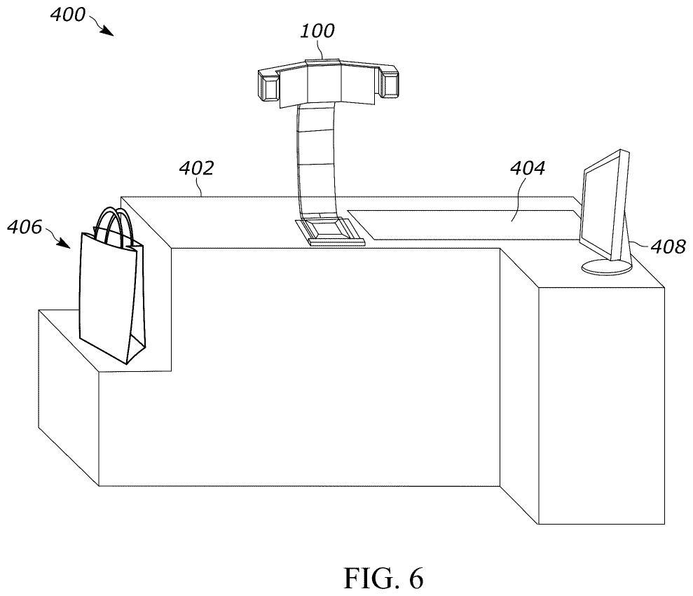

FIG. 6 illustrates an example environment 400 in which the scanner 100 is mounted in a scanning conveyer station 400. The station 400 includes the scanner 100 mounted into a station 402 between a conveyor belt assembly 404 at a lead-in side of the scanner 100 and a bagging area 406 downstream. A work station computer 408 is positioned near an end of the conveyor belt assembly 404 and may be a point of sale computer or other computing device. The environment 400, as shown, may be an employee controller checkout station, for example. Other examples of lead-in and lead-out regions are, of course, possible with the example scanners herein. For example, both the lead-in and lead-out regions may be bagging areas, conveyer areas, roller areas, shopping cart areas, or basket areas. One or both of the lead-in and lead-out regions may be sloped. One or both of the lead-in and lead-out regions may include a weigh scale communicatively coupled to the scanner and/or scanning station to provide weigh data for further facilitating transactions for scanning events. The lead-in and lead-out areas may be any combination of these or other examples herein.

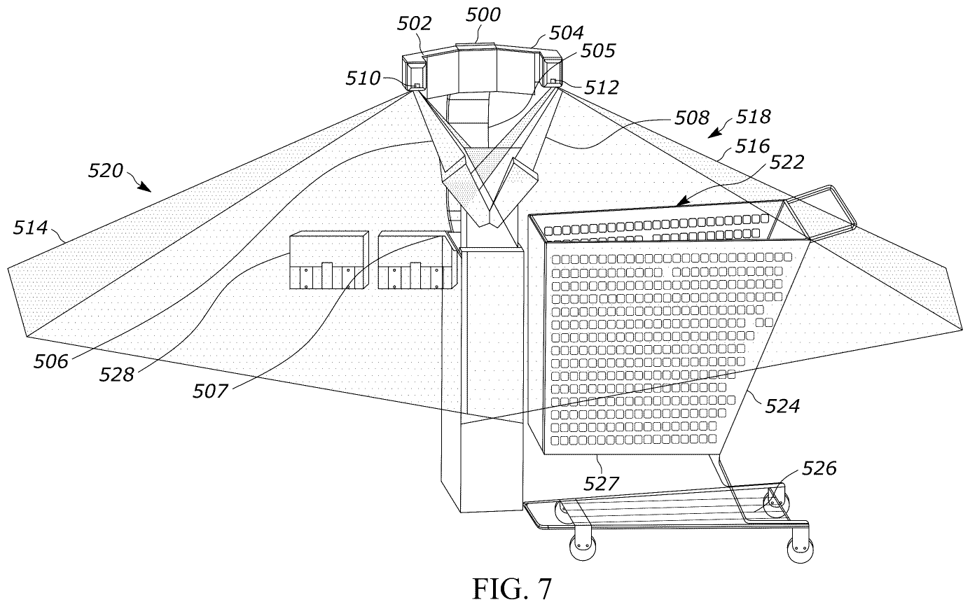

The gateway scanners herein, in some examples, provide object orientation independent object scanning capabilities while simultaneously providing imaging to monitor one or both of the shopping cart area and the bagging area. FIG. 7, for example, illustrates a scanner 500 having a gateway design similar to scanner 100. The scanner 500 includes branching arms 502 and 504 that each include a downwardly directed imagers (not shown) for scanning an object and identifying indicia in image data capture over respective narrow fields of view 506 and 508. These branching arms 502/504 are connected to an extension arm 505 connected to a bottom portion 507. Additionally, however, the branching arms 502 and 504 include respective wide-angle imagers 510 and 512 each having a wide angle field of view 514 and 516, respectively. These wide-angle imagers 510/512 may be vision cameras, such as 2D color vision cameras, or 3D cameras, such as time of flight cameras. The wide-angle imager 512 captures image data over the field of view 516 that expands to cover lead-in region that is a shopping cart area 518, in the illustrated example.

The wide-angle imager 510 captures image data over the field of view 514 that expands to cover a bagging area 520. In the illustrated example, the field of view 516, allows the imager 512 to capture image data over the entire opening 522 of a standard sized shopping cart 524 properly positioned in the shopping cart area 518 and/or over an entire bottom surface 527 of the shopping cart and/or over the entire under tray 526. In this way, the scanner 500 can capture image data of objects exiting the opening 522, objects within the cart portion of the shopping cart 524, or objects positioned on the under tray 526 of the shopping cart 524.

By contrast, the field of view 514 is wide enough to allow the imager 510 to capture image data over the entire bagging area 520, thereby allowing for capturing image data of objects entering the bagging area, objects entering a bag 528 in the bagging area, etc., such that the opening of the bag 528 and the bottom of the bag 528 may be imaged by capturing image data over the field of view 514.

In the illustrated example, the branching arms 502 and 504 each include two types of imagers, narrow FOV imagers (not shown) generating FOVs 506 and 508, respectively, and wide-angle FOV imagers 510 and 512 generating the FOVs 514 and 516, respectively. In other examples, the branching arms 502 and 504 may each have a single wide-angle imager that generates the FsOV 514 and 516 respectively. In some examples, imaging of the scan region is then performed by processing a portion of the imager sensor that corresponds to the portions of the FsOV 514/516 overlapping the scan region. For example, in such configurations, the FOV 506 may be a portion of the FOV 514 for a single imager, and similarly, the FOV 508 may be a portion of the FOV 516 for a single imager. In yet other examples, the branching arms 502 and 504 may be adjustable to accommodate different sized lead-in and lead-out regions. The adjustability may provide lateral adjustment (across the view of FIG. 7), transverse adjustment (into or out of the view of FIG. 7), or angular adjustments. The adjustments may be to/from fixed predefined positions or angles.

Thus, FIG. 7 illustrates, by example, that various scanners herein provide include an upper portion having an upper imaging assembly with two or more wide-angle fields of view, with a first wide-angle field of view directed to extend over a lead-in region adjacent the scanner and a second wide-angle field of view directed extend over a lead-out region adjacent the scanner. Further, as shown in FIG. 7, these two wide-angle fields of view may overlap (see, region 530) each over define a scan region above an exit window of a bottom portion. In some examples, these downwardly directed wide-angle fields of view overlap with one or more upwardly directed fields from images in a bottom portion, to collectively define that scan region. The amount of overlap defining the region 530 may be determined by the position and/or orientation of the imagers in the branching arms 502/504, for example. Further the fanout angle to the wide-angle field of view may determine the amount of overlap as well. Generally, the scan regions formed in the various scanner examples herein may be formed to allow for indicia identification and/or object recognition for tracking objects across the entire area above a bottom surface or an exit window thereof. Moreover, FIG. 7 illustrates, by way of example, that various scanners here have one or more downwardly directly wide-angle fields view that are positioned to define a continuous field of view, that is one that extends from a far edge of the lead-in region to a far edge of the lead-out region, even where a proximal edge of the first wide-angle field view does not extend into the loud-out region and where a proximal edge the second wide-angle field view does not extend into the lead-in region. That is, herein, a continuous field view describes a combination of fields of view that overlap in such a way so as to capture image data over an entire region. Further continuous review of view may be in reference to a desired of angle of captured image data. For example, two wide-angle fields of view may be combined to form a continuous field of view that allows for scanning a barcode on an object so long as a normal extending from that barcode surface forms an angle over a desired range with a normal to the image sensor surface of the imagers defining the continuous field of view.

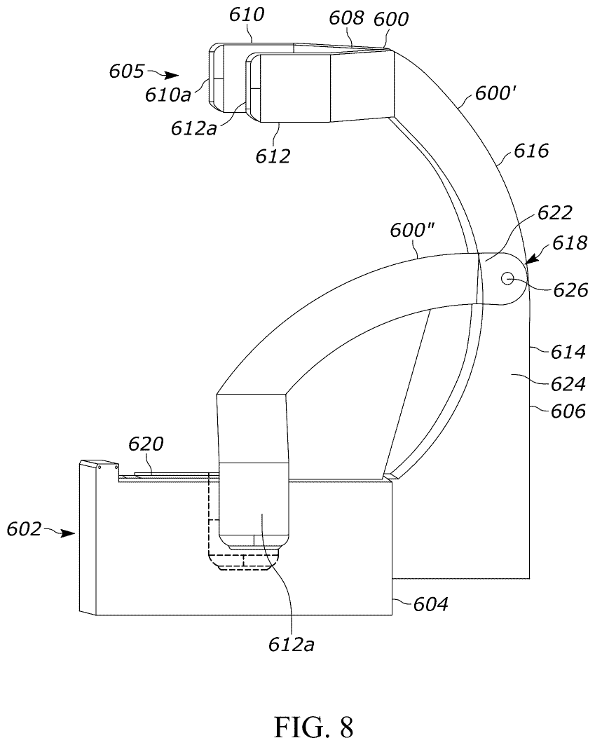

In some examples, it may be desirable for to have a gateway scanner that has different deployment positions, such as a fully erected position for object scanning operation and a folded position that prevents objects scanning operation. Depending on the design, the folded position may be one that allows for efficient porting the gateway scanner from one location to another or for taking the scanner offline so that a user is not allowed access to scan region. FIG. 8 illustrates an example configuration of a scanner 600 that has different deployment positions. The scanner 600 includes a lower portion 602 at which a bottom frame 604 containing one or more upwardly directed imagers and optionally a weight platter (neither shown) is provided. An extension arm 606 having an arcuate inner wall configuration extends from the bottom frame 604 to an upper portion 605 having branching mount 608 formed of a two branching arms 610 and 612, each having one or more downwardly directed imagers. More particularly, the extension arm 606 is formed of first extension arm segment 614 integrated with the bottom frame 604 and extended therefrom and of a second extension arm segment 616 connected to the first extension arm segment 614 at a hinge 618 and extending from that hinge 618 to the branching mount 608. The hinge 618 is configured to have a first position in which the extension arm segments 614 and 616 are erected to extend upwardly so that the scanner 600 has an erected position (labeled 600′) for scanning an object through a scan region. The hinge 618 is further configured to have a second position (labeled 600″) in which the argument segment 616 is downwardly rotatable into a fully folded position in which the branching mount 608 is adjacent to an upper surface 620 of the bottom frame 604. In some examples, the branching arms 610 and 612 are sufficiently dimensioned such that end segments 610a and 612a extend at least partially below the upper surface 620, when in the position 600″.

The hinge 618 may be implemented in various ways, and in the illustrated example is formed from two leaf members 622 (only one visible) formed on the upper extension arm segment 616 and flush with opposing outer walls 624 (only one visible) of the lower extension arm segment 614, with a pin 626 threaded from one leaf to the other and through a bore hole in the upper extension arm segment 616. Of course, any suitable configuration of hinge may be used. Further, the hinge 618 is configured to have a detent or other engagement that forcibly retains the scanner in the different positions 600′ and 600″ against movement out of position, without sufficient force from a user.

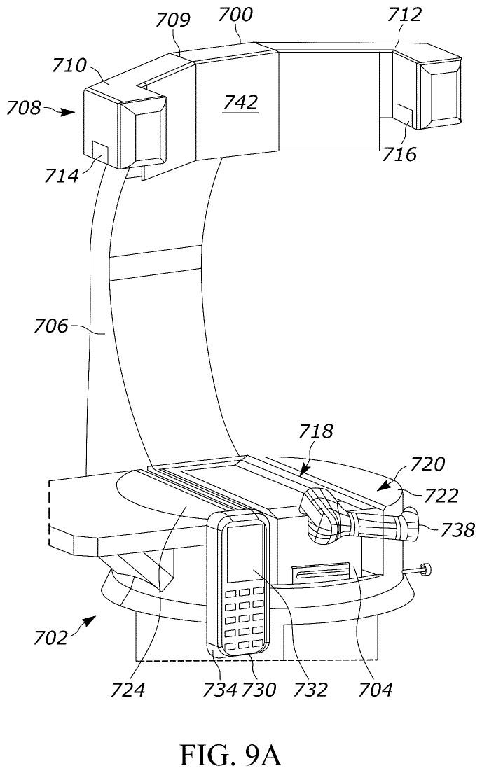

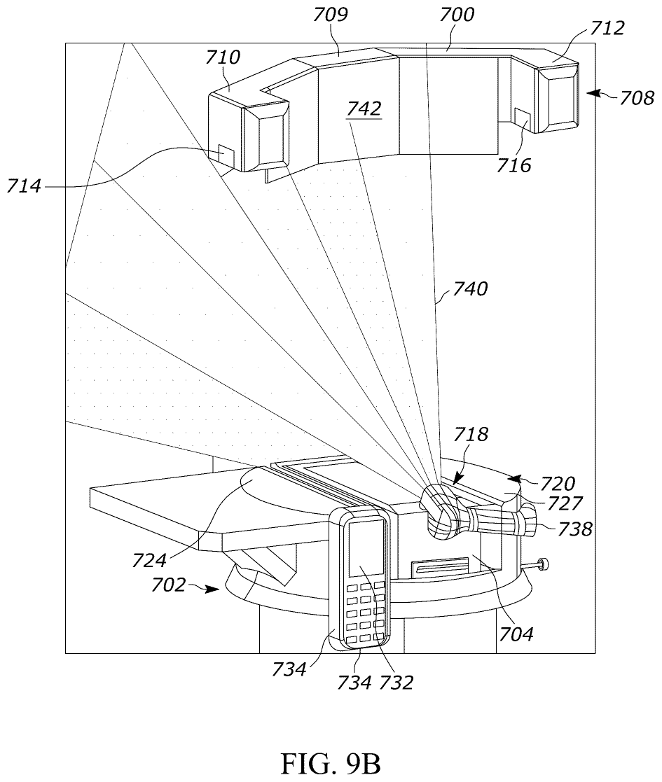

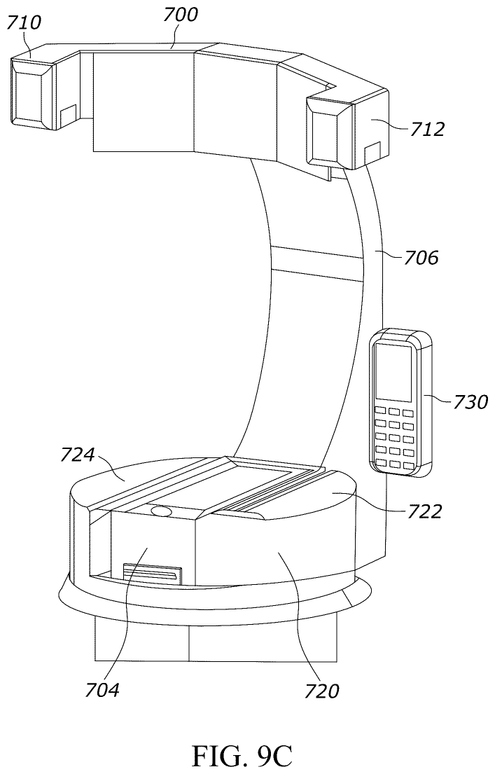

Various gateway scanner examples herein allow for mounting of external components associated with self-check stations, such as user interface terminals. FIGS. 9A and 9B illustrate an example scanner 700 with a lower portion 702 at which a bottom frame 704 containing one or more upwardly directed imagers and optionally a weight platter (neither shown) is provided. An extension arm 706 (shown in FIG. 9A) having an arcuate inner wall configuration extends from the lower portion 702, e.g., from the bottom frame 704, to an upper portion 708 connecting there to at branching mount 709 formed of a two branching arms 710 and 712, each having one or more downwardly directed imagers 714 and 716, respectively.

To facilitate integration of a user payment terminal, the bottom frame 704 is recessed in an opening 718 of a support base 720. The opening 718 extends between a platform portion 722 and a platform portion 724 of the base 720. A computer terminal 730 is mounted to the base 720 to display information related to object scanning on a display 732 and to allow user input through a keypad 734 or other input device. In the illustrated example, the computer terminal 730 is a user payment terminal that includes a credit card swipe slot 736 and which may further include a near field communication (NFC) reader embedded therein to allow for contactless payment.

As mentioned, in some examples, the gateway scanners herein may include back directed imagers having a field of view that is directed toward an extension arm. The scanner 700 illustrates an example configuration, in which the back directed imager is contained within a handheld barcode reader 738 that is mounted to the base 720 such that the, as shown in FIG. 9B, a field of view 740 of the barcode reader 738 extends to overlap with a scan volume and which may be angled upward, i.e., having a central axis that forms an acute angle with a horizontal plane coinciding with an upper surface 738 of the bottom frame 704. In the illustrated example, the FOV 740 is limited such that a vertical extent thereof does not impinge upon a digital display 742 of scanner 700. Limiting the vertical extent avoids any infrared reflections off the display in the case of an IR imager, any reflection of an aimer beam or aim pattern in the case of an imager with integrated aimer assembly, or any reflection of visible illumination in the case of an imager with integrated illumination assembly. FIG. 9C illustrates the scanner 700, but with the computer terminal 730 mounted directly to a side of the extension arm 706, for example, to a mount (not shown). In the scanner 700, the external components (e.g., the computer terminal 730 and barcode reader 738 and printer (not shown)) may be mounted with shared data connection. FIG. 9A thus illustrates that in various examples a gateway scanner, in accordance with the present application, may be configured serve as a point-of-sale (POS) host, where a host printed circuit board (PCB) resides anywhere within the gateway housing and is configured handle the interfacing and control for these peripherals mentioned and the overall conduction of the transaction. The host PCB could also provide the vision analysis and indicia decode functions.

Other gateway scanner configurations are contemplated. I The scanner 100 in FIGS. 1A and 1B includes an upper portion with two branching arms, each positioned to both downwardly and inwardly direct imagers thereby allowing full 360° object orientation independent scanning for indicia. However, in other examples, a scanner having two branching arms like scanner 100 may have a single centrally positioned imaging assembly (e.g., mounted in a central area such as the branching mount). The imaging assembly may be a single imager having two fields of view and internal optics within the branching arms that extends each field of view from the central position into each branching arm to form the offset of the two fields of view made to extend downwardly. In other examples, a scanner can an upper portion that has a single extension arm instead of a branching arm. In some examples, an imaging assembly is mounted in the single extension arm and its corresponding imager has two fields of view that extend downwardly and offset from the center normal of a lower portion of the scanner, by an equal and opposite offset distance.

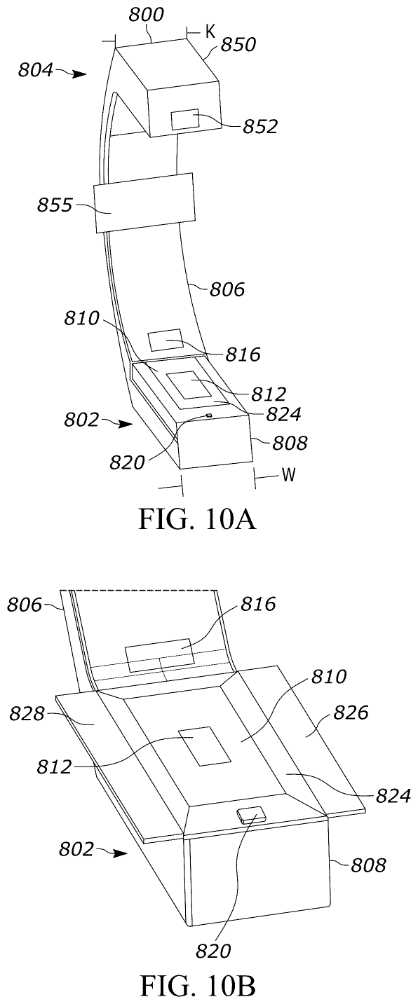

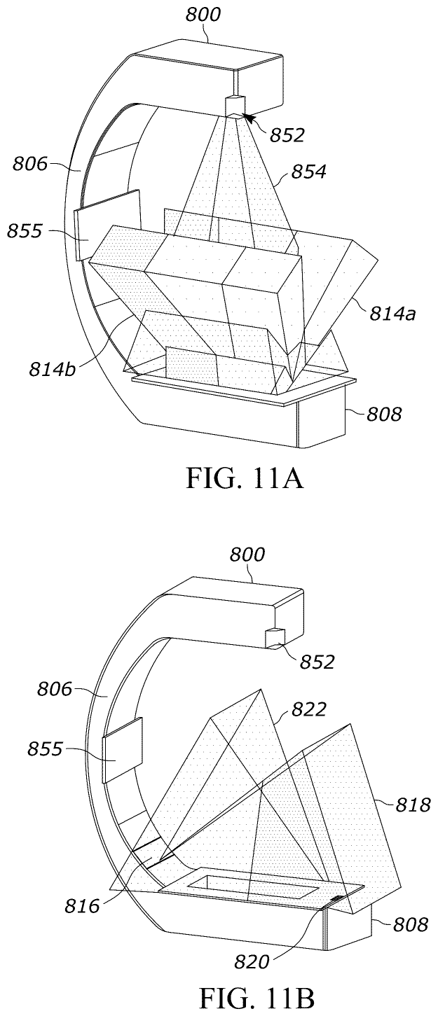

FIGS. 10A and 10B illustrate a narrower scanner design having a single upper portion imager mount. In the exampled example, a scanner 800 includes a lower portion 802, an upper portion 804, and an extension arm 806 extending between the two. The lower portion 802 includes a bottom frame 808 having an exit window 810 and at least one internally mounted upwardly directed imager 812 having a field of view 814 (shown in FIG. 11A). In the illustrated example, an internal mirror (not shown) within the frame 808 is positioned to form the field of view 814 as a split field of view formed of halves 814A and 814B, where each half corresponds to a different portion of the imager array. This configuration allows for using a single upwardly directed imager with a wider field of view.

In an example, in a lower portion of the extension arm 806, a forward directed imager 816 is housed having a field of view facing the location of a user. For example, the imager 816 may be a wide-angle 2D camera for capturing image data of the user during object scanning over a wide-angle field of view 818 (only a central portion of which is shown in FIG. 11B). The imager 816 is mounted adjacent a distal end of the bottom frame 808, while a backward directed imager 820 is mounted in the frame 808 at a proximal end and may have a narrow field of view 822 directed toward the extension arm 806 and overlapping with the field of view 818 coinciding with a scan volume.

The bottom frame 808 houses a weigh platter 824 positioned to measure the weight of objects resting on the exit window 810 or on a transparent, protective screen above the exit window. Additionally, the bottom frame 808 includes two adjustable platter wings 826 and 828 on opposite sides of the bottom frame 808 and extending the length thereof. The platter wings 826 may be adjustable between a deployed position (see, FIG. 10B) and a fully folded position (see, FIG. 10A) in which they are folded flush with outer walls 830 and 832, respectively, of the frame 808. In the deployed position, the platter wings 826/828 provide extended entrance and exit surfacers leading into the scan region coinciding with the exit window 810. In some examples, the exit window 810 is recessed below the height of these platter wings when deployed. Such a bottom frame configuration may be employed in any of the example scanners described herein. In some examples, the platter wings 826/828 may be angled upwardly and/or the platter wings 826/828 may have raised ridges on outer edges so as to create a concave region for the weigh platter 824, so items like produce do not roll off. Of course, in some examples, the outer edges of the bottom surface 808 may be flanged inwardly to create such a concave region.

To provide a narrow profile over the entire vertical extent of the scanner 800, the upper portion 804 includes a single extension arm 850 serving as a mount, instead of a mount feeding two branching arms. In an example, the extension arm 850 mounts one or more downwardly directed imagers 852 having a narrow field of view 854 (shown in FIG. 11A) forming a scan volume with the field of view 814 and the optional fields of view 818 and 822. The scanner 800 is further configured to include a digital display 855 positioned at an interior of the extension arm 806. While not limited to such, the lateral width, K, of the extension arm 850 may be equal to or less than the width, W, of the lower portion 802, such that the upper portion 804 has a width equal to or less than the width of the lower portion 802.

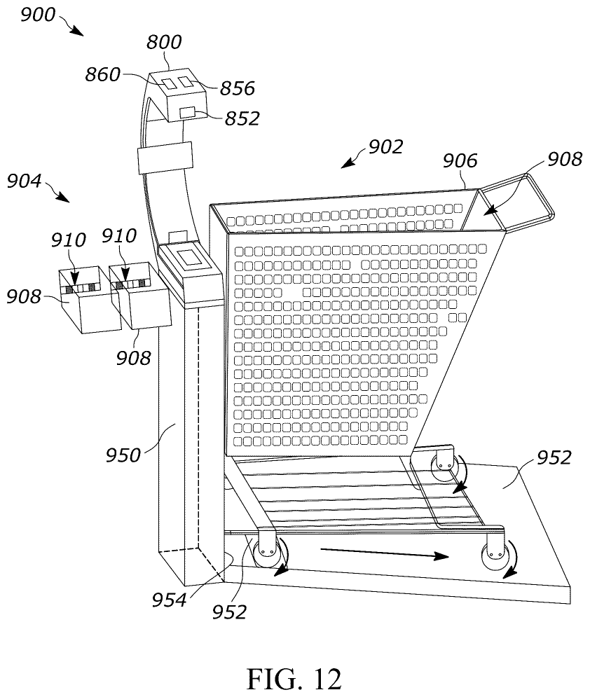

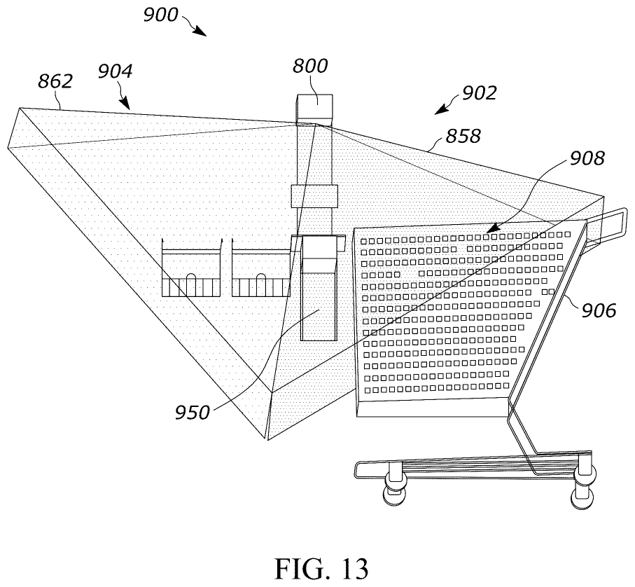

As with the scanner 100, the scanner 800 may be positioned in a self-checkout location 900 (shown in FIG. 12) positioned on a support structure 950 between a shopping cart area 902 and a bagging area 904. As a user moves objects from a shopping cart 906, through the scan volume of the scanner 800, and to bags 908, the scanner 800 scans the object collecting image data from each of the imagers, identifying indicia on the object, for decoding. To facilitate capture of image data over the shopping cart area 902 and the bagging area 904, the branching arm mount 850 may include one or more wide angle imagers, in some implementations. In the illustrated example of FIGS. 12 and 13, a wide-angle imager 856, such as a 2D camera, is positioned within the mount 850 and has field of view 858 that encompasses at least a portion of the shopping cart area 902 and preferably is sufficiently sized to capture image data over the entire opening 908 of the shopping cart 906. Correspondingly, a second imager 860, such as a 2D camera, is positioned within the mount 850 and has a field of view 862 that encompasses at least a portion of the bagging area 904 and preferably is sufficiently sized to capture image data over openings 910 of bags 908 therein. Thus, in some examples, a scanner may be configured to have wide-angle imagers that have wide-angle fields of view that overlap over a scan region (such as shown in FIG. 7) to define a scan volume or combine with other fields of view to define a scan volume, while in other examples (such as shown in FIGS. 12 and 13) the wide-angle fields of view may be directed to (or aperture limited to) extend over respective lead-in or lead-out regions only. Such variations are applicable to any of the wide-angle imager based scanners herein.

In some examples, the support structure 950 includes a shopping cart retaining structure 952 in the form of an integrated ramp platform, in the illustrated example. The retaining structure 952 have may a detent for retaining wheels 912 of the shopping cart 906 in place against moveout out of the shopping cart area 902. The structure 952 may be a bump for positioning under or behind a front wheel of a shopping cart, an electromagnet, a hook, etc. In some examples, the retaining structure may be positioned in a side of a support structure 954, for example an electromagnet or hook.

Further, the support structure 950 may include a trigger assembly communicatively coupled to the scanner 800 to initiate wakeup of the scanner in response to the trigger assembly detecting the presence of the shopping cart 906 in a proper position in the lead-in region (i.e., the shopping cart area 902). That trigger assembly may be, for example, a mechanical push button (not shown) in a detent portion 956 of the retaining structure 952 or extending from a side wall 954 thereof. In yet other examples, an electrical trigger assembly (e.g., an FRID reader, etc.—not shown) or an optical trigger assembly (e.g., an infrared imager, vision camera, barcode reader, etc.—not shown) may be positioned at the side wall 954 for optically detecting the presence an edge of the shopping cart 906. In some examples, a wide-angle field of view of a scanner may be used to detect the presence of a shopping cart. The trigger assembly is an example of a detection assembly. In other examples, the detection assembly may be a downwardly directed looking vision camera assembly, an infrared (IR) sensor assembly, a capacitive sensor assembly, an inductive sensor assembly, or a magnetic sensor assembly.

FIG. 9 illustrates that the present includes narrow scanning stations, whether configured with a scanner like of FIGS. 1, 2, 8, 9A-9C, 10A-14, or any other scanners describe herein, that include a lead-in region for positioning a shopping cart of objects prior to scanning and a lead-out region for storing objects after scanning and a substantially horizontal scanning surface extending fully between an edge of the lead-in region and an edge of the lead-out region. These scanning stations include a scanner positioned between the lead-in region and the lead-out region for scanning the objects from the shopping cart received from the lead-in region, the scanner defining greater than approximately 75% of the substantially horizontal scanning surface. Any of the scanners herein may be positioned as such, including for example a scanner having a plurality of imaging assemblies, each having a field of view, and a housing mounting the plurality of imaging assemblies so that each field of view overlaps with at least one other of the fields of view such that all fields of view collectively form a scan volume. Further the scanning stations may include, among other things, a detection assembly positioned relative to the substantially horizontal scanning surface to detect that the shopping cart is in a correct location in the lead-in region for effecting the transaction.

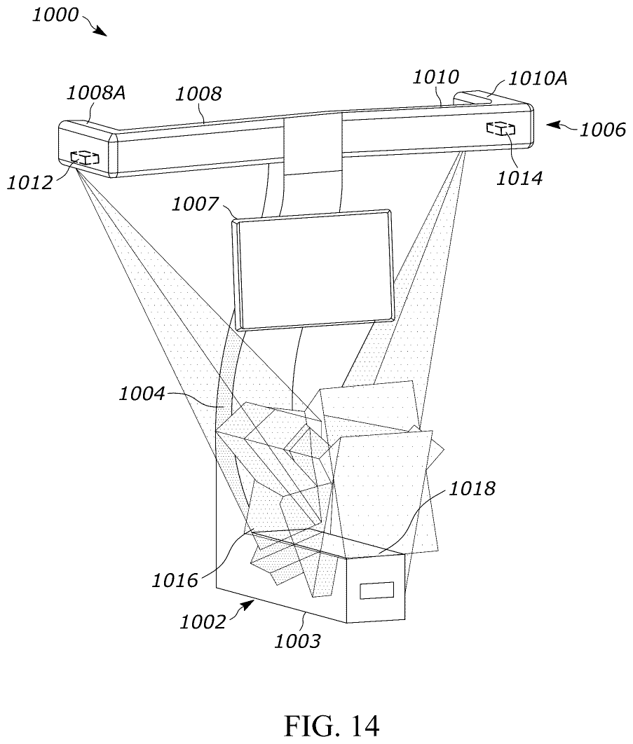

FIG. 14 illustrates another example gateway scanner configuration. A scanner 1000 includes a lower portion 1002 having mounted therein a lower imaging assembly (not shown), exit window (not shown), optionally a weigh platter (not shown), optionally a backward directed imager (not shown), and optionally a forward directed imager (not shown), along with corresponding FsoV (shown). An extension arm 1004 extends from a frame 1003 of the lower portion 1002 to an upper portion 1006 and may include a display screen 1007. The upper portion 1006 includes branching arms 1008 and 1010 with reward extending arm segments 1008A and 1010A, respectively. In this configuration, the extension arm 1004, the upper portion 1006, the branching arms 1008/1010, and/or the arm segments 1008/1010A are configured so that at respective downwardly directed imaging assemblies 1012 and 1014 are positioned reward of a distal edge 1016 of the exit window (or a distal edge of the upper surface of the lower portion 1002), when looking downward from a plan view. The distal edge 1016 is opposite a proximal edge 1018 nearest a user.

It will be appreciated that gateway scanners herein may be characterized as having various features. Scanners may have an extension arm having mounted thereto or therein a forward directed imaging assembly to capture images over a field of view generally directed at the user. For example, an exit window may be at an interior surface of the extension arm with the field of view extending, therefrom. that exit window may be vertically taller than horizontally wide. For example, the vertical length to horizontal width ratio of the exit window in the extension arm may be at least 2:1 or more preferably at least 3:1. The upper portion of the scanner may position the imaging assemblies forward of a rear edge of an exit window in a bottom (platform) portion. The upper portion may be configured to support one or more additional peripherals aside from the imagers. The scanners may have additional horizontal surfaces extending from the bottom portion to level or ramp the upper surface of the bottom portion with external surfaces at a checkout station. The scanners may have upper portions that physically position vision cameras (or position their fields of view) to be above a shopping cart area and above bagging area, respectively, when viewed from above. The scanners may have both one or more vision cameras and one or more barcode imagers attached to the same support, whether a central part of the upper portion, branching arms of the upper portion, or elsewhere. Scanners may have an upper portion that extends at least partially to the left and right of a bottom portion, exit window of the bottom portion, and/or weigh platter. For barcode scanner, the FsOV may be constrained in order to not read items substantially beyond a scan region defined by the lower portion width up to a certain height, e.g., 5″ above the exit window of the lower portion.

It will be appreciated that the gateway scanners herein may be used in various methods. For example, the gateway scanners may be used in a method of scanning products, where a product carrier is positioned at one side of a scanner and where a bagging area is positioned at the other side of a scanner and wherein the distance between the product carrier and the bagging area is no more than 15 inches (e.g., from between 10 inches and 15 inches) and wherein the scanner partially surrounds a vertical plane between the product carrier and the bagging area, the vertical plane being positioned such that an object being moved between the product carrier and bagging area must past through it, and wherein the scanner is configured to capture indicia positioned on any side of an object moving through the vertical plane.

More generally, gateway scanners herein may, in various examples, have multiple imagers contained within a support structure that includes an opening on the user side to facilitate the passage of items and a lower portion that includes horizontal exit windows, behind which cameras are positioned. That support structure further includes an extension arm above the horizontal windows in order to allow the passage of larger items. These multiple imagers may be positioned so that indicia may be captured on any side of an object within a scan volume contained within an open volume created by the support structure. Further upward directed imagers and the downward directed imagers may be sufficiently tilted to achieve enough resolution to read indicia on the leading and trailing sides of an object being passed through the scan volume.

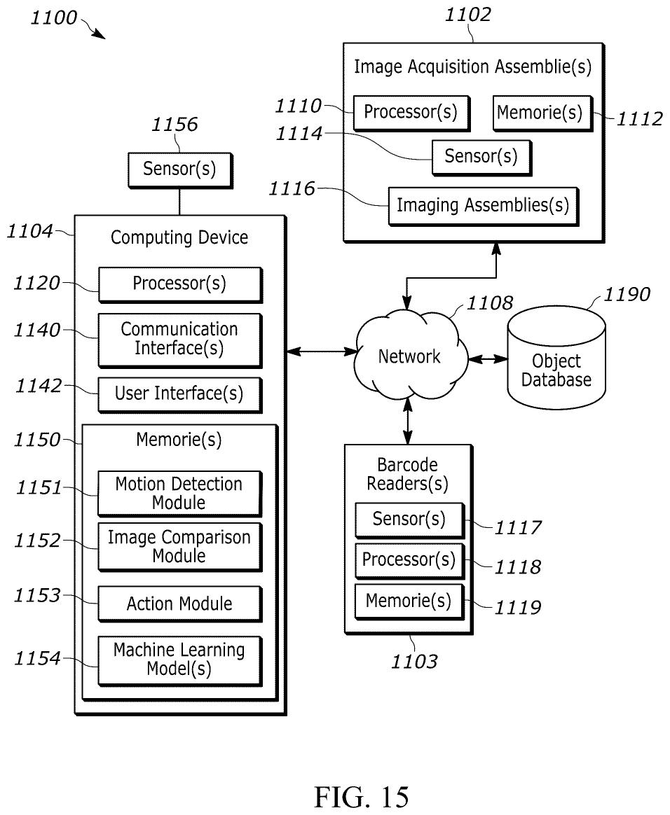

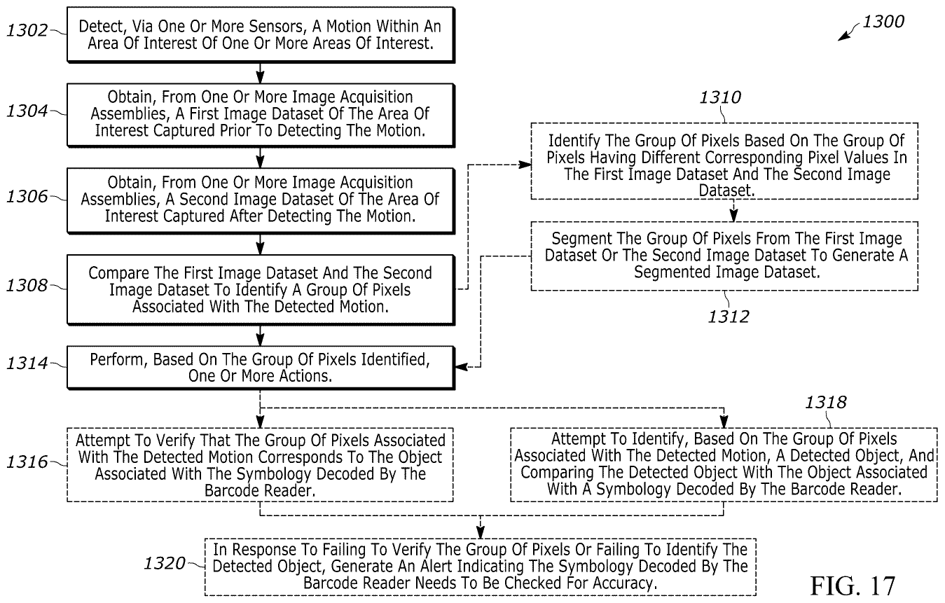

FIG. 15 is a block diagram representative of an example computing environment 1100 capable of implementing the example methods and/or operations described herein, including, for example, one or more steps of the method 1300 of FIG. 17. The example computing environment 1100 of FIG. 15 includes image acquisition assemblies 1102 (e.g. imager 166 and/or imager 168 of FIG. 1), barcode readers 1103 (e.g., example scanner 100 of FIGS. 1-6), a computing device 1104 (e.g., a server, a mobile computing device, an external computing device, another suitable computing device, etc.), and/or a database 1190, each of which may be configured to communicate with one another via a network 1108. The network 1108 may be a single communication link directly connecting the computing device 1104 and the image acquisition assemblies 1102 and/or the barcode reader 1103 (e.g., a direct wireless link), or one or more networks 1108 may include multiple links and/or communication networks of one or more types (e.g., one or more wired and/or wireless local area networks (LANs), and/or one or more wired and/or wireless wide area networks (WANs) such as the Internet, public networks, private networks, etc.). For ease of reading herein (and not for limitation purposes), the one or more networks 1108 may be referred to using the singular tense.

The example image acquisition assemblies 1102 of FIG. 15 include one or more processors 1110 (e.g., one or more microprocessors, controllers, and/or any suitable type of processor), one or more memories 1112 (e.g., volatile memory, non-volatile memory) accessible by the processors 1110 (e.g., via a memory controller), one or more sensors 1114, and one or more imaging assemblies 1116. In some embodiments, the image acquisition assemblies 1102 are positioned proximate to a self-checkout station and each have a respective FOV directed towards the an area of interest proximate to the self-checkout station. For example, the one or more areas of interest may be a bagging area, an item conveyer belt, a scanning area, etc.

The processors 1110 may be capable of implementing computer-executable instructions stored on the memory 1112. The memories 1112 (e.g., volatile memory, non-volatile memory) may be accessible by the processors 1110 (e.g., via a memory controller), and may interact with the memories 1112 to obtain, for example, machine-readable instructions stored in the memories 1112 corresponding to, for example, the operations represented by the flowchart 1300 shown at FIG. 17. Additionally or alternatively, machine-readable instructions corresponding to the example operations described herein may be stored on one or more removable media (e.g., a compact disc, a digital versatile disc, removable flash memory, etc.) that may be coupled to the image acquisition assemblie(s) 1102 to provide access to the machine-readable instructions stored thereon.

The one or more memories 1112 may include instructions for capturing image datasets (e.g., one or more digital images) of an area of interest within the FOV of the image acquisition assemblies 1102. The one or more sensors 1114 may be, or may include, hardware sensors (e.g., image sensors) configured to capture image data (for example, the image datasets) corresponding to the FOV of the sensors 1114. In some embodiments, the sensors 1114 may be integrated with the imaging assemblies 1116, and the imaging assemblies 1116 may have also have a FOV directed towards an area of interest proximate to the self-checkout station. Additionally, the imaging assemblies 1116 may be configured to assemble image data captured by the one or more sensors 1114 into an image dataset corresponding to one or more FOV of the image acquisition assemblies 1102 and/or to one or more areas of interest. In various embodiments, the one or more image acquisition assemblies 1116 are configured to capture image datasets, or digital images, continuously and sequentially. In some embodiments, the image acquisition assemblies 1102 may be configured to capture a sequence of images over a duration of time and store the sequence of images in the memories 1112, such as a first image dataset captured prior to the detected motion and a second image dataset captured after the detected motion In such embodiments, the image acquisition assemblies 1102 may be communicatively coupled to a network (e.g., the network 1108) such that the image acquisition assemblies 1102 may exchange data with other devices/components (e.g., the example computing device 1104) of the system 1100. Further, the image acquisition assemblies 1102 may send captured image datasets to the computing device 1104, for example, in response to a request from computing device 1104 for images captured at a particular time and/or from a particular FOV (e.g., image datasets captured before and/or after the detected motion in a particular area of interest associated with the checkout station).

The example barcode reader 1103 of FIG. 15 includes one or more sensors 1117, one or more processors 1118 (e.g., one or more microprocessors, controllers, and/or any suitable type of processor), and one or more memories 1119 (e.g., volatile memory, non-volatile memory) accessible by the processors 1118 (e.g., via a memory controller). The one or more sensors 1117 may be, or may include, hardware sensors configured to obtain image data corresponding to a FOV of the sensors 1117. The processors 1118 may be capable of implementing computer-executable instructions stored on the memory 1119. The memories 1119 (e.g., volatile memory, non-volatile memory) may be accessible by the processors 1118 (e.g., via a memory controller), and may interact with the memories 1119 to obtain, for example, machine-readable instructions stored in the memories 1119 corresponding to, for example, the operations represented by the flowchart 1300 shown at FIG. 17. Additionally or alternatively, machine-readable instructions corresponding to the example operations described herein may be stored on one or more removable media (e.g., a compact disc, a digital versatile disc, removable flash memory, etc.) that may be coupled to the barcode reader(s) to provide access to the machine-readable instructions stored thereon. The one or more memories 1119 may include instructions for decoding a symbology (e.g., a barcode, QR code, or other indicia) depicted within a FOV of one of the barcode readers 1103 (i.e., within the FOV of the one or more sensors 1117). For instance, the FOVs of the barcode readers may correspond to the various areas of interest associated with the self-checkout station, such that the barcode reader 103 may decode symbologies affixed to or otherwise associated with objects in the areas of interest.

The example computing device 1104 may be capable of executing instructions to, for example, implement operations of the example methods described herein, as may be represented by the flowcharts of the drawings that accompany this description. Other example computing environments capable of, for example, implementing operations of the example methods described herein include field programmable gate arrays (FPGAs) and application specific integrated circuits (ASICs). The example computing device 1104 of FIG. 15 may be an individual server, a group (e.g., cluster) of multiple servers, a mobile computing device (e.g., a smart phone, a tablet, a laptop, a wearable device, etc.), or another suitable type of computing device or system (e.g., a collection of computing resources). In some aspects the computing device 1104 may be a personal portable device of a user. For example, the computing device 1104 may be the property of a customer, a company, an organization, etc.

The computing device 1104 may include one or more processors 1120, one or more communication interfaces 1140, one or more user interfaces 1142, and/or one or more memories 1150.

The processors 1120 may include, for example, one or more microprocessors, controllers, and/or any suitable type of processor. Generally, the processors 1120 may be capable of implementing computer-executable instructions stored on the memories of the example computing environment 1100 (e.g., the memories 1150, the memories 1112, the memories 1119, and/or other memories).

The communication interface 1140 enables communication between the computing device 1104 and other devices (e.g., including the image acquisition assemblies 1102, the barcode readers 1103, and/or the object database 1190) via, for example, one or more networks (e.g., network 1108). The example communication interface 1140 includes any suitable type of communication interface(s) (e.g., wired and/or wireless interfaces) configured to operate in accordance with any suitable protocol(s). For example, the communication interfaces 1140 may be configured to transmit and receive data using a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wireless communication protocols. The communication interfaces 1140 may include one or more transceivers to support various different wireless communication protocols; however, as previously mentioned, for ease of reading (and not limitation purposes) herein, the one or more communication interfaces 1140 may be referred to herein using the singular tense.

The example computing device 1104 of FIG. 15 also includes one or more user interfaces 1142 to enable receipt of user input, communication of output data to the user and/or to present/display information to the user. The user interface 1142 may include one or more suitable types of user input devices, such as keyboards, touch screen displays, microphones, and/or any suitable types of remote and/or local user input devices. Further, the user interface 1142 may include one or suitable types of output devices, such as touch screen displays, speakers, mice, touch pads, and the like. In various embodiments, the user interface 1142 may include a display/screen that may use any suitable display technology (e.g., LED, OLED, LCD, etc.), and in some embodiments may be a touchscreen display. For example, user interface 1142 may enable a user to view confirmation messages associated with items scanned at a self-checkout station. Further, the user interface 1142 may be an integral user interface that enables a user of the computing device 1104 to interact with graphical user interfaces (GUIs) provided by computing device 1104. AS another example, the user interfaces 1142 may enable a user to view or physically interacting with a GUI including one or more scanned objects presented on the displays/screens. In some embodiments, the user interfaces 1142 may include one or more local interfaces, and/or may include one or more remote interfaces that are communicatively connected to the computing device 1104 via the network 1108 (e.g., that are provided by an application, web browser, or other software executing on a device of a user). For ease of reading (and not limitation) purposes, user interfaces 1142 may be referred to herein using the singular tense. In some embodiments, components of the user interface 1142 (e.g., a example display/screen of the user interface 1142) may not be integral to the computing device 1104 and may receive instructions from the computing device 1104 via wired and/or wireless transmissions over communication interface 1140, for example.

The memories 1150 (e.g., volatile memory, non-volatile memory) may be accessible by the processors 1120 (e.g., via a memory controller), and may interact with the memories 1150 to obtain, for example, machine-readable instructions stored in the memories 1150 corresponding to, for example, the operations represented by the flowchart 1300 shown at FIG. 17. Additionally or alternatively, machine-readable instructions corresponding to the example operations described herein may be stored on one or more removable media (e.g., a compact disc, a digital versatile disc, removable flash memory, etc.) that may be coupled to the computing device 1104 to provide access to the machine-readable instructions stored thereon. The example memories 1150 may include one or more set of computer executable instructions/modules for implementing the techniques disclosed herein for recognizing items during self-checkout, including a motion detection module 1151, an image comparison module 1152, an action module 1153, and machine learning models 1154.

The example motion detection module 1151 of FIG. 15 may include computer-executable instructions for logging data associated with a detected motion (i.e., a motion within an area of interest of one or more areas of associated with the one or more image acquisition assemblies 1102) obtained from a motion sensor of the example computing environment 1100 (e.g., the sensors 1114 of the image acquisition assemblies 1102). In various embodiments, the logged data may include time data (e.g., time stamps for time of capture) associated with image datasets captured by, for example, the image acquisition assemblies 1102 at the various FOVs (i.e., at various areas of interest). In this way, another component of the example computing environment 1100 (e.g., the image comparison module 1152) may access sequences/indexed image data associated with a detected motion captured at FOVs associated with respective areas of interest.

The example image comparison module 1152 of FIG. 15 may include computer executable instructions for comparing digital images, or image datasets, to identify a group of pixels associated with a detected motion. The image comparison module 1152 may include instructions for suitable image analysis techniques including edge detection, computer vision, image segmentation, object detection, image denoising, etc. The image comparison module 1152 may include instructions for obtaining, e.g., from the image acquisition assemblies 1102, a first image dataset (e.g., a digital image) associated with an area of interest that was captured prior to the detected motion logged by the motion detection module 1151, and a second image dataset (e.g., a digital image) associated with the area of interest that was captured after the detected motion.

In some embodiments, identifying the group of pixels associated with a detected motion is based on the one or more subgroups of contiguous pixels identified exceeding a threshold number of pixels. In variations of these embodiments, the image comparison module 1152 may include instructions for determining a pixel change average of the differences in pixel value for each respective subgroup of contiguous pixels based on the difference in pixel value between corresponding pixels in the image datasets being compared (e.g., the first image dataset and the second image dataset obtained by the motion detection module 1151). Further to that end, identifying the group of pixels may be based on the one or more subgroups of contiguous pixels exceeding a threshold pixel change average (e.g., a threshold pixel value change average). In various embodiments and more generally, the image comparison module 1152 may include instructions for comparing characteristics, or image features, (i.e., the object data stored in the object database 1190) of an object associated with a symbology scanned by a barcode reader (i.e., the barcode readers 1103) with characteristics, or image features, of the identified group of pixels (e.g., a size of the group of pixels, a color of the group of pixels, a shape of the group of pixels). In some embodiments, the image comparison module 1152 may include instructions for identifying the group of pixels based on the group of pixels having different corresponding pixel values in the digital images, or image datasets, being compared.

In various embodiments, the image comparison module 1152 includes instructions for segmenting the identified group of pixels from one of the image datasets being compared to generate a segmented image dataset. In some embodiments, the image comparison module 1152 may generate a segmented image dataset by, for example, setting all pixels representing the background of the image datasets to a default color or value, and/or by setting other identified groups of pixels (e.g., not the group of pixels associated with the detected motion) that are present in both the image datasets to a default color or value. Accordingly, pixels that changed across the image datasets (e.g., the group of pixels associated with the detected motion) may be analyzed without delegating processing time and/or computational resources to analyzing unchanged pixels in the image datasets. In some embodiments, the image comparison module 1152 may include instructions for analyzing such segmented image datasets (e.g., using the machine learning models 1154, another suitable machine learning model, or using other image analysis techniques) to identify an object depicted within the segmented image dataset. Additionally and/or alternatively, the image comparison module 1152 may include instructions for identifying subgroups of contiguous pixels (e.g., clusters of pixels, pixels sharing a common border, pixels close together, etc.) in the identified group of pixels and segmenting the one or more subgroups of contiguous pixels from one of the image datasets being compared to generate the segmented image dataset.

The example action module 1153 of FIG. 15 may include computer executable instructions for performing one or more actions based on the group of pixels identified by the image comparison module 1152. In some embodiments the action module 1153 may include instructions for verifying and/or identifying an object associated with a symbology decoded by a barcode reader (e.g., one of the barcode readers 1103) within a threshold period of time corresponding to the detected motion (e.g., the duration of the detect motion, a period of time encompassing the detected motion, etc.). Moreover, the action module 1153 may verify that the objected associated with the symbology can/may be represented by the group of pixels identified by the image comparison module 1152. In some embodiments, an object may be verified based on comparing the object associated with the symbology and the object associated with the group of identified pixels. Moreover, known characteristics (image characteristics and/or features associated with an object available to the users) of the object associated with the symbology (i.e., the scanned object) may be compared with characteristics, or image features, of the identified group of pixels (e.g., a size of the group of pixels, a color of the group of pixels, a shape of the group of pixels, etc.). In some embodiments, the one or more actions include attempting to identify, based on the group of pixels associated with the detected motion, a detected object. In variations of this embodiment, the one or more actions include comparing the detected object with the object associated with a symbology decoded by the barcode reader (i.e., a scanned object). In some embodiments, the one or more actions include attempting to verify that the group of pixels associated with detected motion (i.e., the detected object) corresponds to the object associated with the symbology decoded by the barcode reader (i.e., the scanned object). For example, the actions may include determining whether the characteristics of the scanned object and the characteristics of the detected object are the same characteristics (with some degree of certainty). In some embodiments, the one or more actions include generating an alert indicating the symbology decoded by the barcode reader needs to be checked for accuracy in response to failing to verify the group of pixels or failing to identify the detected object.

The one or more example machine learning models 1154 of FIG. 15 may include any number of suitable machine learning models 1154 (e.g., an artificial neural network, a convolutional neural network, a random forest classifier, a computer vision model, etc.). Although not depicted in FIG. 15, the one or more memories 1150 may include one or more machine learning model training applications that include instructions for training and/or fine-tuning the machine learning models 1154. The machine learning models 1154 may be trained on labelled image features of known objects, or characteristics of known objects, stored in the object database 1190. In this way, when image data depicting an unknown object is input to the machine learning models 1154, the machine learning models 1154 can predict and/or identify the unknown object depicted in image data. In some embodiments, the machine learning models 1154 may be used to verify that a group of pixels identified (e.g., by the image comparison module 1152) corresponds to an object associated with a symbology decoded by the barcode reader (e.g., the barcode readers 1103). In some embodiments, the machine learning models 1154 may be used to identify the detected object.

As an example, a machine learning model 1154 may be trained to analyze data associated with an object (e.g., an object of the catalog of objects available to an individual at a brick-and-mortar location) and to identify image features or characteristics of the object. The machine learning model 1154 may be trained by a machine learning model training application using training data including images, or image datasets, associated with various known objects available to an individual at a brick-and-mortar location. In some embodiments, the image datasets, and associated image features, included in the training data may be labeled with their respective known objects. For instance, each image and/or image dataset may be labeled to indicate image features such as the color, size, shape, etc. of the known object depicted in the image, and these labeled images may be used as training data. Once sufficiently trained using this training data, such a machine learning model 1154 may be applied to a new image, video, and/or image dataset associated with an unknown object (e.g., an image dataset captured by the image acquisition assemblies 1102 upon a detected motion within an area of interest of the one or more areas of interest) to identify the unknown object.

In some examples, one or more machine learning model(s) 1154 may be executed on the computing device 1104, while in other examples one or more machine learning model(s) 1154 may be executed on another computing system, separate from the computing device 1104. For instance, the computing device 1104 may send data to another computing system, where a trained machine learning model 1154 is applied to the data, and the other computing system may send a prediction or identification, based upon applying the trained machine learning model 1154 to the data, to the computing device 1104. Moreover, in some examples, one or more machine learning models 1154 may be trained by respective machine learning model training applications executing on the computing device 1104, while in other examples, one or more machine learning model(s) 1154 may be trained by respective machine learning model training application(s) executing on another computing system, separate from the computing device 1104.

Whether the machine learning model(s) 1154 are trained on the computing device 1104 or elsewhere, the machine learning model(s) 1154 may be trained by respective machine learning model training application(s) using training data (including historical data in some cases), and the trained machine learning model(s) 1154 may then be applied to new/current data that is separate from the training data in order to determine, e.g., predictions and/or identifications related to the new/current data.

In various aspects, the machine learning model(s) 1154 may comprise machine learning programs or algorithms that may be trained by and/or employ neural networks, which may include deep learning neural networks, or combined learning modules or programs that learn in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the machine learning model(s) 1154 may comprise a library or package executed on the computing device 1104 (or other computing devices not shown in FIG. 15). For example, such libraries may include the TENSORFLOW based library, the PYTORCH library, and/or the SCIKIT-LEARN Python library.

Machine learning may involve identifying and recognizing patterns in existing data (such as training a model based upon historical data) in order to facilitate making predictions or identification for subsequent data (such as using the machine learning model 1154 on new/current data order to determine a prediction or identification related to the new/current data).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

In addition, the example memories 1150 of FIG. 15 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memories 1150 may include instructions for carrying out any of the steps of the methods described herein (such as the method 1300 discussed with respect to FIG. 17) via an algorithm executing on the processors 1120. It should be appreciated that one or more other applications may be envisioned and that are executed by the processor(s) 1120. It should be appreciated that given the state of advancements of mobile computing devices, any or all of the processes functions and steps described herein may be present together on a mobile computing device.

The object database 1190 may store data associated with a catalog of objects available for a user at a particular brick and mortar location (e.g., food items/objects at a grocery store). The data stored in the object database 1190 may be image features associated with a specific object (e.g., a size, a color, a shape, etc.). The data stored in the object database 1190 may be obtained by performing image analysis on a digital image known to depict a specific object in order to extract image features unique to the known object. The object database 1190 may store image features labelled with a corresponding known object depicted in a digital image. Moreover, an artificial neural network or another suitable machine learning model (e.g., the machine learning model 1154) may be trained on the labelled image features stored in the object database 1190. In this way, when presented with a digital image depicting an unknown object, the artificial neural network can identify the unknown object depicted in the digital image. In some embodiments, the data stored in the object database 1190 may alternatively be stored in a different memory of the computing environment 1100 (e.g., the memory 1150 of the computing device 1104).

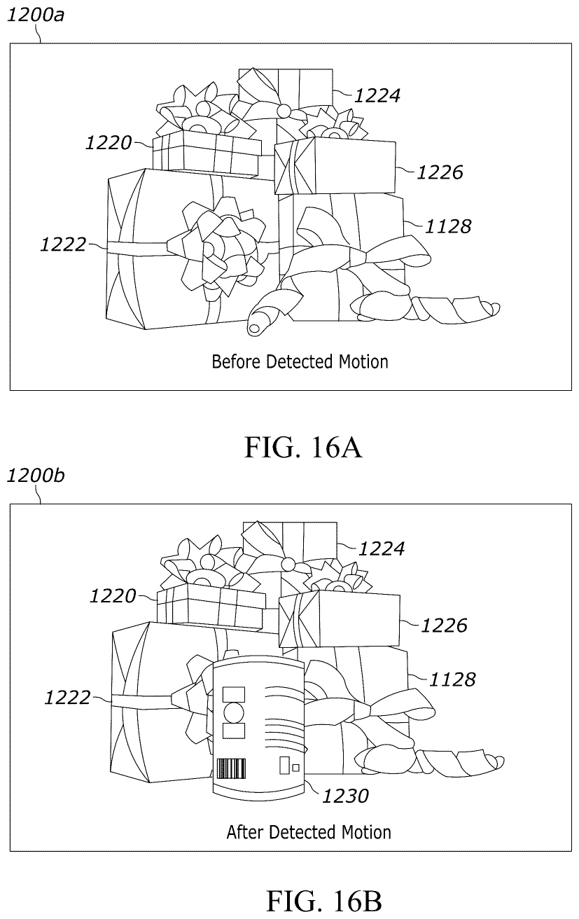

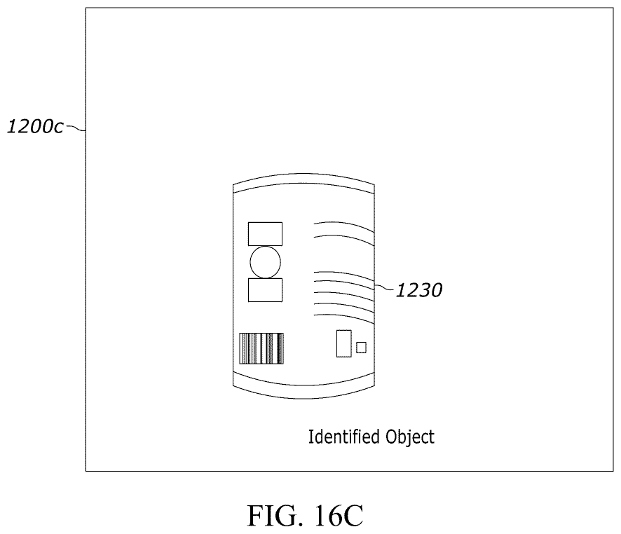

FIG. 16A and FIG. 16B are exemplary image datasets (i.e. image dataset 1200a and image dataset 1200b respectively) of a checkout area obtained in response to detecting a motion within the checkout area. The example image datasets 1200a-1200b may be captured in accordance with operations of the example methods described herein, as may be represented by the flowcharts of the drawings that accompany this description. FIG. 16A and FIG. 16B depict example image datasets 1200a-1200b, or digital image(s) 1200, of a plurality of objects 1220-1228 (object 1220, object 1222, object 1224, object 1226, and object 1228) within an area of interest of (e.g., a bagging area) associated with the checkout area, and captured: by an imaging device (e.g., the example image acquisition assemblies 1102 of FIG. 15), and within the FOV of the imaging device and/or within an area of interest included in the FOV of the imaging device. Although the image dataset 1200a of FIG. 16A and the image dataset 1200b of FIG. 16B are respectively labeled before detected motion and after detected motion, it should be understood these labels are for ease of reading (and not limitation purposes). Moreover, depending on the FOV of the checkout area, the example image datasets 1210 may be reversed. For example, in scenarios where the FOV of the imaging device is directed towards a loading area associated with the checkout area of interest, a detected item would generally appear in the image dataset captured before the detected motion. As an example alternative and as depicted in FIG. 16A and FIG. 16B, in scenarios where the FOV is directed towards, for example, a bagging area, a detected item (i.e., object 1230 in example image dataset 1200b) would generally appear in the image dataset captured after the detected motion.

For example, FIG. 16A depicts an example image dataset 1200a of a bagging area associated with a checkout station of interest. The image dataset 1200a includes the plurality of objects 1220-1228, all of which are within the bagging area before the detected motion. FIG. 16B depicts an example image dataset 1200b of the same bagging area depicted in FIG. 16A, after the detected motion. The image dataset 1200b includes the plurality of objects 1220-1228 and an additional object 1230, all of which are within the bagging area after the detected motion. Generally, many of the techniques disclosed herein relate to identifying an additional object, e.g., additional object 1230 (also referred to herein as identified object 1230, new object 1230, etc.).

FIG. 16C is an exemplary segmented image dataset 1200c that solely includes the additional object 1230, such that the additional object 1230 may be identified. Segmented image dataset 1200c may be generated by segmenting pixels comprising or composing the additional object 1230 in image dataset 1200b of FIG. 16A from the remainder of the image dataset 1200a. In example scenarios that include a FOV directed towards a loading area associated with the checkout station/area of interest, the segmented image dataset 1200c may be generated by segmenting the pixels comprising an additional object in the image dataset captured prior to the detect motion.

In various embodiments, generating the segmented image dataset 1200c includes identifying a group of pixels based on the group of pixels having different corresponding pixel values in the image dataset 1200a and the image dataset 1200b and segmenting the group of pixels from one of the image dataset (i.e., from the image dataset captured prior to the detected motion or from the image dataset captured after the detected motion) to generate the segmented image dataset 1200c. Additionally and/or alternatively, generating the segmented image dataset 1200c includes identifying one or more subgroups of contiguous pixels in the group of pixels (e.g., a partially covered object, more than one additional object, a heavily shadowed image dataset, etc.) and segmenting the one or more subgroups of contiguous pixels from one of the image datasets (i.e., image dataset captured prior to the detected motion or the image dataset captured after the detected motion), thereby generating the segmented image dataset 1200c. In some embodiments, generating the segmented image dataset 1200c includes identifying the group of pixels is based on the one or more subgroups of contiguous pixels identified exceeding a threshold number of pixels. In some embodiments, generating the segmented image dataset 1200c includes determining, based on the differences in pixel value between corresponding pixels in the image datasets, a pixel change average of the differences in pixel value for each respective subgroup of contiguous pixels, and identifying the group of pixels is based on the one or more subgroups of contiguous pixels exceeding a threshold pixel change average.

FIG. 17 depicts an exemplary computer-implemented method 1300 for implementing the techniques for recognizing items during self-checkout disclosed herein, according to an aspect. The method 1300 may be implemented by the processors 1120, the processors 1110, the processors 1118, and/or other suitable processors, etc., executing instructions stored on the memories 1150, the memories 1112, the memories 1119, and/or another suitable non-transitory computer readable medium, etc., described above with respect to FIG. 1-16.

The method 1300 may begin at block 1302 when a motion within an area of interest of one or more areas of interest is detected via one or more sensors (e.g., the sensors 1114 and/or the sensors 1117). At block 1304, a first image dataset of the area of interest, captured prior to the detected motion (e.g., image dataset 1200a of FIG. 16A), is obtained from one or more image acquisition assemblies (e.g., the image acquisition assemblies 1102). At block 1306, a second image dataset of the area of interest, captured after the detected motion (e.g., image dataset 1200b of FIG. 16B), is obtained from the one or more image acquisition assemblies 1102. At block 1308, the first image dataset and the second image dataset are compared to identify a group of pixels associated with the detected motion (e.g., the group of pixels associated with the additional object 1230, depicted in image dataset 1200c of FIG. 16C). For example, the first and second image datasets may be compared to identify pixels added or removed from the image datasets after a motion has been detected. In some embodiments, comparing the first image dataset and the second image dataset may include identifying a group of pixels based on the group of pixels having different corresponding pixel values in the first image dataset and the second image dataset, for example, as depicted at block 1310. In variations of these embodiments, comparing the first image dataset and the second image dataset may include segmenting the group of pixels from the first image dataset or the second image dataset to generate a segmented image dataset (e.g., the segmented image dataset 1200c), for example as depicted at block 1312. In some embodiments, block 1312 may include setting all pixels representing the background of the first image dataset or the second image dataset (e.g., the pixels not included in the identified group of pixels associated with the detected motion) to a default color or value. In a variation of these embodiments, comparing the first image dataset and the second image dataset (e.g., as discussed with respect to block 1308) may include analyzing the segmented image dataset to identify an object. At block 1314, one or more actions are performed based on the group of pixels identified as discussed with respect to block 1308 and/or block 1310.

In some embodiments, the one or more actions may include verifying whether an object identified based on the group of pixels associated with the detected motion corresponds to an object identified based on a symbology scanned by a barcode reader, as depicted at block 1316. Further, block 1316 may include identifying an object that is associated with a symbology that was decoded by a barcode reader at or near the time of the motion (e.g., a threshold period of time before or after the time of the motion). That is, the object added to or removed from an area of interest may be affixed with a symbology (e.g., a barcode, QR code, or other indicia), and the symbology may be decoded by the barcode reader before the object is added to a different area of interest, or after the object is removed from the area of interest. For example, the symbology associated with the object may be decoded by the barcode reader before the object enters a bagging area of interest and/or the symbology associated with the object may be decoded by the barcode reader after the object is removed from a cart area of interest. Moreover, block 1316 may include verifying (or attempting to verify) that these objects are the same object.

In some embodiments, the one or more actions may include identifying a detected object based on the group of pixels associated with the detected motion and comparing the detected object to a known object (e.g., the object associated with a symbology decoded by the barcode reader), as depicted at block 1318. In some embodiments, the one or more actions may include, in scenarios where the group of pixels is not verified and/or in scenarios where a detected object is not identified, generating an alert indicating the symbology decoded by the barcode reader needs to be checked for accuracy, as depicted at block 1320. In various embodiments, the alert may be presented on a display (e.g., a display of an associated self-checkout station, a backend display, etc.). Generally, the method 1300 may include verifying whether the object associated with the symbology may be represented by the group of pixels identified as discussed with respect to block 1308, and/or block 1310. For example, the object associated with the symbology as discussed with respect to block 1316 and/or block 1318 may correspond to known image features and/or characteristics (e.g., a known shape, color, size, etc. of the object) which may be compared to the identified group of pixels (e.g., using suitable image analysis techniques).

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a computing environment. As used herein, the term “computing environment” is expressly defined as a physical device including at least one hardware component configured (e.g., via operation in accordance with a predetermined configuration and/or via execution of stored machine-readable instructions) to control one or more machines and/or perform operations of one or more machines. Examples of a computing environment include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example computing environments, such as ASICs or FPGAs, are specifically configured hardware for performing operations (e.g., one or more of the operations described herein and represented by the flowcharts of this disclosure, if such are present). Some example computing environments are hardware that executes machine-readable instructions to perform operations (e.g., one or more of the operations described herein and represented by the flowcharts of this disclosure, if such are present). Some example computing environments include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more computing environments (e.g., processor(s)). In some examples, the operations described herein are implemented by one or more configurations of one or more specifically designed computing environments (e.g., ASIC(s)). In some examples the operations described herein are implemented by a combination of specifically designed computing environment(s) and machine-readable instructions stored on a medium (e.g., a tangible machine-readable medium) for execution by computing environment(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. An imaging system comprising:
one or more processors;
one or more sensors;
one or more image acquisition assemblies configured to capture image datasets associated with one or more areas of interest; and
one or more memories including computer-executable instructions stored thereon that, when executed by the one or more processors, cause the imaging system to:
detect, via the one or more sensors, a motion within an area of interest of the one or more areas of interest;
obtain, from the one or more image acquisition assemblies, a first image dataset of the area of interest captured prior to the detected motion;
obtain, from the one or more image acquisition assemblies, a second image dataset of the area of interest captured after the detected motion;
compare the first image dataset and the second image dataset to identify a group of pixels associated with the detected motion; and
perform, based on the group of pixels identified, one or more actions.

2. The imaging system of claim 1, further comprising:
a barcode reader; and
the one or memories including computer-executable instructions stored thereon that, when executed by the one or more processors, cause the imaging system to:
identify, via the barcode reader, an object associated with a symbology decoded by the barcode reader within a threshold period of time corresponding to the detected motion; and
verify the object associated with the symbology may be represented by the group of pixels.

3. The imaging system of claim 2, wherein the object is verified based on comparing characteristics of the object associated with the symbology with one or more of: (i) a size of the group of pixels, (ii) a color of the group of pixels, or (iii) a shape of the group of pixels.

4. The imaging system of claim 2, wherein the one or more actions include one or more of:
(i) attempting to verify that the group of pixels associated with the detected motion corresponds to the object associated with the symbology decoded by the barcode reader;
(ii) attempting to identify, based on the group of pixels associated with the detected motion, a detected object, and comparing the detected object with the object associated with a symbology decoded by the barcode reader; and
(iii) in response to failing to verify the group of pixels or failing to identify the detected object, generate an alert indicating the symbology decoded by the barcode reader needs to be checked for accuracy.

5. The imaging system of claim 4, wherein an artificial neural network is used to (i) verify that the group of pixels corresponds to the object associated with the symbology decoded by the barcode reader and (ii) identify the detected object.

6. The imaging system of claim 1, wherein comparing the first image dataset and second image dataset further comprises:
identifying the group of pixels based on the group of pixels having different corresponding pixel values in the first image dataset and the second image dataset;
segmenting the group of pixels from the first image dataset or the second image dataset to generate a segmented image dataset; and
analyzing the segmented image dataset to identify an object.

7. The imaging system of claim 6, wherein segmenting the group of pixels from the first image dataset or the second image dataset further comprises:
identifying one or more subgroups of contiguous pixels in the group of pixels; and
segmenting the one or more subgroups of contiguous pixels from the first image dataset or the second image dataset, thereby generating the segmented image dataset.

8. The imaging system of claim 7, wherein identifying the group of pixels is based on the one or more subgroups of contiguous pixels identified exceeding threshold number of pixels.

9. The imaging system of claim 8, including computer-executable instructions stored thereon that, when executed by the one or more processors, cause the imaging system to:
determine, based on differences in pixel value between corresponding pixels in the first image dataset and the second image dataset, a pixel change average of the differences in pixel value for each respective subgroup of contiguous pixels.

10. The imaging system of claim 9, wherein identifying the group of pixels is based on the one or more subgroups of contiguous pixels exceeding a threshold pixel change average.

11. The imaging system of claim 1, wherein the one or more image acquisition assemblies are positioned proximate to a self-checkout station and wherein the one or more areas of interest are proximate to the self-checkout station.

12. The imaging system of claim 11, wherein each image acquisition assembly includes a respective imaging assembly that has a field of view (FOV) directed towards a respective area of interest of the one or more areas of interest proximate to the self-checkout station.

13. A computer-implemented method comprising:
detecting, via one or more sensors, a motion within an area of interest of one or more areas of interest;
obtaining, from one or more image acquisition assemblies, a first image dataset of the area of interest captured prior to the detected motion;
obtaining, from the one or more image acquisition assemblies, a second image dataset of the area of interest captured after the detected motion;
comparing the first image dataset and the second image dataset to identify a group of pixels associated with the detected motion; and
performing, based on the group of pixels identified, one or more actions.

14. The method of claim 13, further comprising:
identifying, via a barcode reader, an object associated with a symbology decoded by the barcode reader within a threshold period of time corresponding to the detected motion; and
verifying the object associated with the symbology may be represented by the group of pixels.

15. The method of claim 14, wherein the object is verified based on comparing characteristics of the object associated with the symbology with one or more of: (i) a size of the group of pixels, (ii) a color of the group of pixels, or (iii) a shape of the group of pixels.

16. The method of claim 14, wherein the one or more actions include one or more of:
(i) attempting to verify that the group of pixels associated with the detected motion corresponds to the object associated with the symbology decoded by the barcode reader;
(ii) attempting to identify, based on the group of pixels associated with the detected motion, a detected object, and comparing the detected object with the object associated with a symbology decoded by the barcode reader; and
(iii) in response to failing to verify the group of pixels or failing to identify the detected object, generate an alert indicating the symbology decoded by the barcode reader needs to be checked for accuracy.

17. The method of claim 16, wherein an artificial neural network is used to (i) verify that the group of pixels corresponds to the object associated with the symbology decoded by the barcode reader and (ii) identify the detected object.

18. The method of claim 13, wherein comparing the first image dataset and second image dataset further comprises:
identifying the group of pixels based on the group of pixels having different corresponding pixel values in the first image dataset and the second image dataset;
segmenting the group of pixels from the first image dataset or the second image dataset to generate a segmented image dataset; and
analyzing the segmented image dataset to identify an object.

19. The method of claim 18, wherein segmenting the group of pixels from the first image dataset or the second image dataset further comprises:
identifying one or more subgroups of contiguous pixels in the group of pixels; and
segmenting the one or more subgroups of contiguous pixels from the first image dataset or the second image dataset, thereby generating the segmented image dataset.

20. The method of claim 19, wherein identifying the group of pixels is based on the one or more subgroups of contiguous pixels identified exceeding threshold number of pixels.

21. The method of claim 20, further comprising:
determining, based on differences in pixel value between corresponding pixels in the first image dataset and the second image dataset, a pixel change average of the differences in pixel value for each respective subgroup of contiguous pixels.

22. The method of claim 21, wherein identifying the group of pixels is based on the one or more subgroups of contiguous pixels exceeding a threshold pixel change average.

23. The method of claim 13, wherein the one or more image acquisition assemblies are positioned proximate to a self-checkout station and wherein the one or more areas of interest are proximate to the self-checkout station.

24. The method of claim 23, wherein each image acquisition assembly includes a respective imaging assembly that has a field of view (FOV) directed towards a respective area of interest of the one or more areas of interest proximate to the self-checkout station.
